(19) United States
(12) Patent Application Publication
(10) Pub. No.: US 2011/0120661 A1
(43) Pub. Date: May 26, 2011

(54) INTEGRATED WEAVING TYPE THREE-DIMENSIONAL CURTAIN SHEET FABRIC HAVING BANDS AND MANUFACTURING METHOD THEREOF

(76) Inventor: Ok-Ja Kim, Gyeongsangbuk-do (KR)

(21) Appl. No.: 12/886,358

(22) Filed: Sep. 20, 2010

(30) Foreign Application Priority Data
Nov. 23, 2009 (KR) 10-2009-113492
Nov. 23, 2009 (KR) 10-2009-113493

(51) Int. Cl. E06B 9/384; E06B 9/386; D03D 23/00

(52) U.S. Cl. 160/89; 160/236; 139/383 R

(57) ABSTRACT

The present invention relates to a three-dimensional curtain sheet fabric having front and rear bands in the integrated-weaving type, and the invention provides three-dimensional curtain sheets 2 and 200 in the integrated triple-woven type on which front and rear bands 114 and 110 isolated at certain intervals right and left are arranged on the front and the back of a plurality of awning sheets 112 which are arranged up and down, wherein rear connecting portions 116 for connecting the central awning sheets 112 and the rear bands 110 in the warp and weft integrated-weaving type are formed on upper side edges of the central awning sheets 112 while front connecting portions 118 for connecting the front bands 114 and the central awning sheets 112 in the warp and weft integrated-weaving type are formed on lower side edges of the central awning sheets 112, thereby configuring the three-dimensional curtain sheet fabric 200. As another example, it is possible to configure the three-dimensional curtain sheet fabric 2 by replacing the rear bands 110 with mesh sheets 10. Therefore, the invention can easily control the awning and floodlighting without a glimmering phonemonon by the three-dimensional curtain sheet having front connection bands or front and rear connection bands, and have good ventilation and transparency since floodlighting portions are opened to the front or opened back and forth when the floodlighting portions are formed. Furthermore, the invention can be manufactured easily in the integrated-weaving type and show superior durability.

### FIELD OF THE INVENTION

The present invention relates to a window shielding apparatus, and more specifically, to a beautiful three-dimensional curtain sheet fabric and a method for manufacturing the three-dimensional curtain sheet fabric thereof, which can be woven integratedly while the awning and floodlighting are easily controlled without a glimmering phonemonon, and have good ventilation and transparency and be manufactured easily and further have a stereoscopic decorative beauty.

### BACKGROUND ART

In general, window shielding apparatuses are used for the interior decoration as well as for privacy or blocking or controlling the quantity of light. There are various kinds of window shielding apparatuses such as curtains, verticals, blinders, Roman shades, window tintings, roll screens and the like, and the consumers may purchase and install the desired products by considering certain purposes, window structure, and their own taste.

Among these apparatuses, the roll screens control the height of screen fabric by rolling up or unrolling down the screen fabric corresponding to a curtain. Since the roll screens control an awning degree by adjusting the screen fabric in the vertical direction, the screen fabric should be rolled down even to the lower section of a window for a perfect awning effect and further, the screen fabric has to be rolled up even to the upper section of the window in order to fully put away an awning of the screen fabric. If the user wants a partial awning effect, the user may roll up the screen fabric up to a desried random position. However, such roll screens cause the user's inconvenience of frequently pulling up and down a lift chain to fully open and close the screen fabric.

Besides, among the window shielding apparatuses, the blinds shield the sun by binding and hanging louvers which are made of thin and narrow metal boards, wooden boards, plastic boards and the like, at certain intervals, and the inclination of the boards is controlled according to an angle of rays by using strings for adjusting the inclination of the boards and strings for lifting up the whole boards, thereby rolling up the entire blinds. Although these blinds are mainly used for office windows, in recent years, as blinds made of various materials including cloth, paper and others are introduced, they are being used for home decoration a lot. In the case of normal blinds, each blind is respectively equipped with a rotational lever for integratedly rotating a plurality of louvers and an operating rope for moving each louver up and down. Therefore, the blinds may have disadvantages like brightness controlling is complicated and they are heavier than the roll screens.

As a window shielding apparatus having strong points of a blind and a roll screen which respectively have both advantages and disadvantages, there exists a blind on which a front mesh-type curtain sheet, a rear mesh-type curtain sheet, and a shielding curtain sheet for shielding the light are integratedly connected. But, such a blind may cause the user's eyes to feel so tired because of a glimming phenomenon if the front mesh-type curtain sheet and the rear mesh-type curtain sheet for ventilation are arranged together back and forth to have the ventilating and transparency effects.

As an example of solving this disadvantage, Korea Patent Registration No. 10-0876183 “Curtain sheet fabric and window shielding apparatus thereof” (PCT Publication No. WO 2009/1482219) is disclosed. The aforementioned registered patent sets forth a three-dimensional curtain sheet on which mesh sheets are not overlapped together, wherein awning cover sheets are woven on the mesh sheets, and each awning cover sheet is opened and closed by an opening/closing vertical yarn, thereby eliminating the glimmering before the eyes when the front and rear mesh sheets are overlapped. The above preceding registered patent has the advantage of removing the glimmering phenomenon and easily controlling the degree of ventilation and transparency.

But, the prior art of such an example has a possibility that a person, for instance, a child may strongly and carelessly pulling an awning cover sheet after the curtain is installed on the window. In this case, the awning sheet fixed to an opening/closing vertical yarn is slightly isolated from its fixed position whereby the shape of the awning cover sheet may be creased or crushed a little, resulting in the unpretty appearance during shading.

### DISCLOSURE

### Technical Solution

It is therefore an object of the present invention to provide a beautiful integrated weaving-type three-dimensional curtain sheet fabric and a method for manufacturing the three-dimensional curtain sheet fabric, which can form a three-dimensional curtain sheet in the integrated weaving type and easily control the awning and floodlighting without a glimmering phonemonon, and have good ventilation and transparency and be manufactured easily and further have a stereoscopic decorative beauty.

### SUMMARY OF THE INVENTION

To accomplish the above object, the present invention provides a curtain sheet fabric comprising a three-dimensional curtain sheet 2 in the integrated triple-woven type on which a plurality of awning cover sheets 12 are arranged up and down on bottom mesh sheets 10 and connection bands 14 isolated at certain intervals are arrayed right and left on the awning cover sheets 12, wherein upper connecting portions 16 for connecting the bottom mesh sheets 10 with the awning cover sheets 12 in the warp and weft integrated-weaving type are formed on each upper side edge of the awning cover sheets 12 while lower connecting portions 18 for connecting the awning cover sheets 12 with the connection bands 14 in the warp and weft integrated-weaving type are formed on each lower side edge of the awning cover sheets 12, and before the lower side edges of the awning cover sheets 12 are separated and opened, cut yarns 40 for cutting warps that connect the lower side connecting portions 18 of the awning cover sheets 12 and the bottom mesh sheets 10 are formed in the vicinity between the bottom mesh sheets 10 and the rear upper connecting portions 16 and wefts which should be sheared are positioned between the adjacent connection bands 14.

In addition, the present invention provides a manufacturing method of a three-dimensional curtain sheet fabric for forming a plane curtain sheet fabric in the integrated triple-woven type on which a plurality of awning cover sheets 12 that consist of warp LM yarns and awning wefts are vertically arranged on bottom mesh sheets 10 of which at least one of warps and wefts is an LM yarn, and connection bands 14 that are made of warp LM yarns and band wefts and isolated at certain intervals are horizontally arrayed on the awning cover sheets 12, wherein cut yarns 40 for cutting warps that connect lower connecting portions 18 of the awning cover sheets 12 and the bottom mesh sheets 10 are positioned in the vicinity between upper connecting portions 16 and the bottom mesh sheets 10 after being injected in the weft type, and the upper connecting portions 16 for connecting the bottom mesh sheets 10 with the awning cover sheets 12 in the warp and weft integrated-weaving type including LM yarns as wefts are formed on each upper side edge of the awning cover sheets 12 while the lower connecting portions 18 for connecting the awning cover sheets 12 with the connection bands 14 in the warp and weft integrated-weaving type including LM yarns as wefts are formed on each lower side edge of the awning cover sheets 12 whereby the plane curtain sheet fabric may be obtained, and after heat treatment is applied to the obtained curtain sheet fabric, the wefts existing among the connection bands 14 are sheared and turned over at the back, then the cut yarns 40 are pulled over to separate and open the lower connecting portions 18 of the awning cover sheets 12 from the bottom mesh sheets 10, thereby obtaining a final three-dimensional curtain sheet.

Also, the present invention provides a curtain sheet fabric for forming a three-dimensional curtain sheet 2 in the integrated triple-woven type on which a plurality of awning cover sheets 12 are vertically arranged on bottom mesh sheets 10 and connection bands 14 horizontally isolated at certain intervals are arrayed on the awning cover sheets 12, wherein upper connecting portions 16 for connecting the awning cover sheets 12 with the bottom mesh sheets 10 in the warp and weft integrated-weaving type are formed on each upper side edge of the awning cover sheets 12 while lower connecting portions 18 for connecting the awning cover sheets 12 with the connection bands 14 in the warp and weft integrated-weaving type are formed on each lower side edge of the awning cover sheets 12, and the respective warps of the bottom mesh sheets 10, the awning cover sheets 12, the connection bands 14, and the upper and lower connecting portions 16 and 18 are LM yarns and the wefts of the upper connecting portions 16 and the lower connecting portions 18 are mixed with LM yarns.

Further, the present invention provides a curtain sheet fabric for forming a three-dimensional curtain sheet 200 in the integrated triple-woven type on which front and rear bands 114 and 110 horizontally isolated at certain intervals are arrayed on the front and the back of a plurality of central awning sheets 112 which are arranged up and down, wherein rear connecting portions 116 for connecting the central awning sheets 112 with the rear bands 110 in the warp and weft integrated-weaving type are formed on each upper side edge of the central awning sheets 112 while front connecting portions 118 for connecting the front bands 114 with the central awning sheets 112 in the warp and weft integrated-weaving type are formed on each lower side edge of the central awning sheets 112, and before the front and rear connecting portions which are connected together after woven are separated, front cut yarns 149 for cutting awning warps that connect the front connecting portions 118 of the central awning sheets 112 and the rear bands 110 in the front direction are arranged and woven in the weft type in the vicinity of the front connecting portions 118, and rear cut yarns 142 for cutting awning warps that connect the front bands 114 and the rear connecting portions 116 of the central awning sheets 112 in the rear direction are arranged and woven in the weft type in the vicinity of the rear connecting portions 116, and respective wefts 150 and 154 which should be sheared are positioned between the adjacent front bands 114 and the adjacent rear bands 110.

Further, the present invention provides a manufacturing method of a three-dimensional curtain sheet fabric for forming a plane curtain sheet in the integrated triple-woven type on which front and rear bands 114 and 110 horizontally isolated at certain intervals are arrayed on the front and the back of a plurality of awning sheets 112 which are arranged up and down, wherein rear connecting portions 116 for connecting the central awning sheets 112 with the rear bands 110 in the warp and weft integrated-weaving type are formed on each upper side edge of the central awning sheets 112 while front connecting portions 118 for connecting the front bands 114 with the central awning sheets 112 in the warp and weft integrated-weaving type are formed on each lower side edge of the central awning sheets 112, and front cut yarns 140 for cutting awning warps that connect the front connecting portions 118 of the central awning sheets 112 and the rear bands 110 in the front direction are arranged and woven in the weft type in the vicinity of the front connecting portions 118, and rear cut yarns 142 for cutting awning warps that connect the front bands 114 and the rear connecting portions 116 of the central awning sheets 112 in the rear direction are arranged and woven in the weft type in the vicinity of the rear connecting portions 116 whereby the plane curtain sheet fabric may be obtained, and after heat treatment is applied to the obtained curtain sheet fabric, wefts 150 and 154 existing among the front and rear bands 114 and 110 are sheared, and the front and rear cut yarns 140 and 142 are pulled over to cut some warps of the awning sheets, thereby finally forming a three-dimensional curtain sheet fabric 200.

Further, the present invention provides a curtain sheet fabric for forming a three-dimensional curtain sheet 200 in the integrated triple-woven type on which front and rear bands 114 and 110 horizontally isolated at certain intervals are arrayed on the front and the back of a plurality of awning sheets 112 which are arranged up and down, wherein rear connecting portions 116 for connecting the central awning sheets 112 with the rear bands 110 in the warp and weft integrated-weaving type are formed on each upper side edge of the central awning sheets 112 while front connecting portions 118 for connecting the front bands 114 with the central awning sheets 112 in the warp and weft integrated-weaving type are formed on each lower side edge of the central awning sheets 112, and the warps of the central awning sheets 112, the front and rear bands 114 and 110, and the front and rear connecting portions 118 and 116 are LM yarns, and the wefts of the front and rear connecting portions 118 and 116 are either LM yarns or mixed yarns including the LM yarns.

### Advantageous Effects

Since the present invention realizes a three-dimensional curtain sheet fabric having bands on one side or on both sides in the integrated-weaving type, the awning and floodlighting of the three-dimensional curtain sheet can easily be controlled without a glimmering phonemonon and the sheet is easily manufactured, and further, the invention has the advantage of showing superior durability without the transformation of a shape even though the curtain is strongly pulled by the user after being installed on the window. Likewise, the invention has a stereoscopic decorative beauty by forming various patterns on the three-dimensional curtain sheet.

### BRIEF DESCRIPTION OF THE DRAWINGS

FIG. 1 is a perspective view of a three-dimensional curtain sheet fabric for a window shielding apparatus in accordance with one embodiment of the present invention.

FIG. 2 is an expanded perspective view showing a front part's middle of the three-dimensional curtain sheet fabric of FIG. 1.

FIG. 3 is a vertical side sectional view of a three-dimensional curtain sheet fabric in accordance with one embodiment of the present invention.

FIGS. 4A and 4B are expanded perspective views showing middle parts of front and rear parts before a three-dimensional curtain sheet fabric woven in the triple type in accordance with the present invention is cut by weft shearing and cutting warps.

FIG. 5 shows a one-repeat weaving diagram related to main parts of a three-dimensional curtain sheet fabric in accordance with one embodiment of the present invention.

FIG. 6 is a diagram for describing a triple-weaving process of a three-dimensional curtain sheet fabric in accordance with one embodiment of the present invention.

FIG. 7 to FIG. 10 are perspective views for describing a triple-weaving process related to sectors S1 to S4 of FIG. 5.

FIG. 11 is a perspective view of a window shielding apparatus having a three-dimensional curtain sheet fabric in accordance with one embodiment of the present invention.

FIG. 12 and FIG. 13 are side sectional views for describing a state of an awning portion and a floodlighting portion of the present invention being formed.

FIG. 14 is a perspective view of a three-dimensional curtain sheet fabric for a window shielding apparatus in accordance with another embodiment of the present invention.

FIG. 15 is an expanded perspective view showing a middle part of the three-dimensional curtain sheet fabric of FIG. 14.

FIG. 16 is a side sectional view of a three-dimensional curtain sheet fabric in accordance with another embodiment of the present invention.

FIG. 17 is a one-repeat weaving diagram related to main parts of a three-dimensional curtain sheet fabric in accordance with another embodiment of the present invention.

FIG. 18 is a weaving perspective view before a three-dimensional curtain sheet fabric woven in the triple type according to another embodiment of the present invention is cut by front and rear weft shearing and cutting warps.

FIG. 19 and FIG. 20 are diagrams for describing a triple-weaving process for manufacturing a three-dimensional curtain sheet according to another embodiment of the present invention.

FIG. 21 is a perspective view of a window shielding apparatus for mounting the three-dimensional curtain sheet fabric of FIG. 14.

FIG. 22 and FIG. 23 are side sectional views for describing an operated state of the three-dimensional curtain sheet of FIG. 21.

FIG. 24 is a perspective view of a window shielding apparatus having a transformed three-dimensional curtain sheet fabric in accordance with one embodiment of the present invention.

### DETAILED DESCRIPTION OF PREFERRED EMBODIMENTS

From now on, the preferred embodiments will be described in detail by referring to the accompanied drawings.

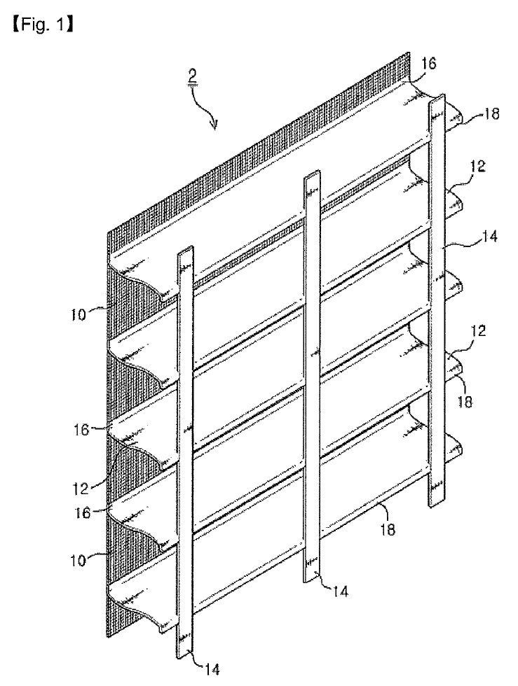

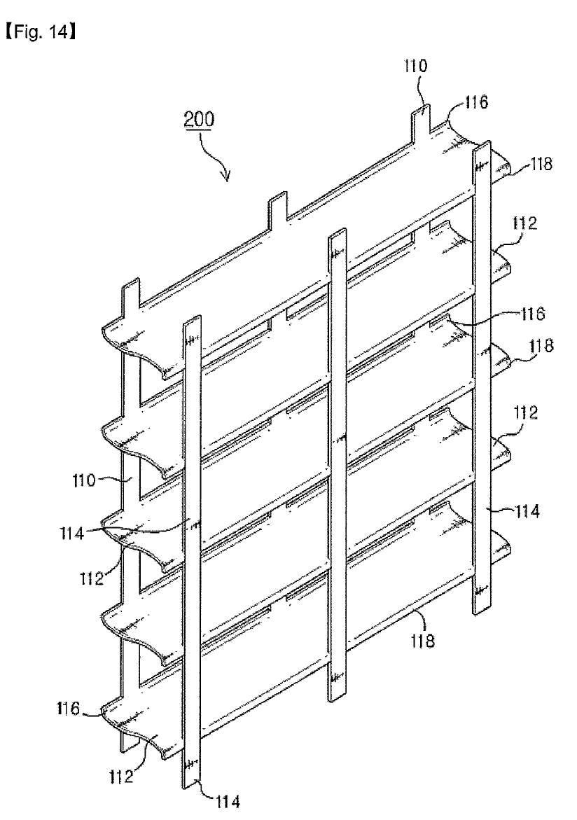

FIG. 1 to FIG. 13 are diagrams related to an integrated-weaving type three-dimensional curtain sheet fabric having connection bands on one side in the integrated-weaving type, showing one embodiment of the present invention. FIG. 14 to FIG. 23 are diagrams related to an integrated-weaving type three-dimensional curtain sheet fabric having connection bands on front and rear sides in the integrated-weaving type, showing another embodiment of the present invention.

First, the integrated-weaving type three-dimensional curtain sheet fabric having the connection bands on the one side in the integrated-weaving type according to the one embodiment of the present invention will be described in reference to FIG. 1 to FIG. 13.

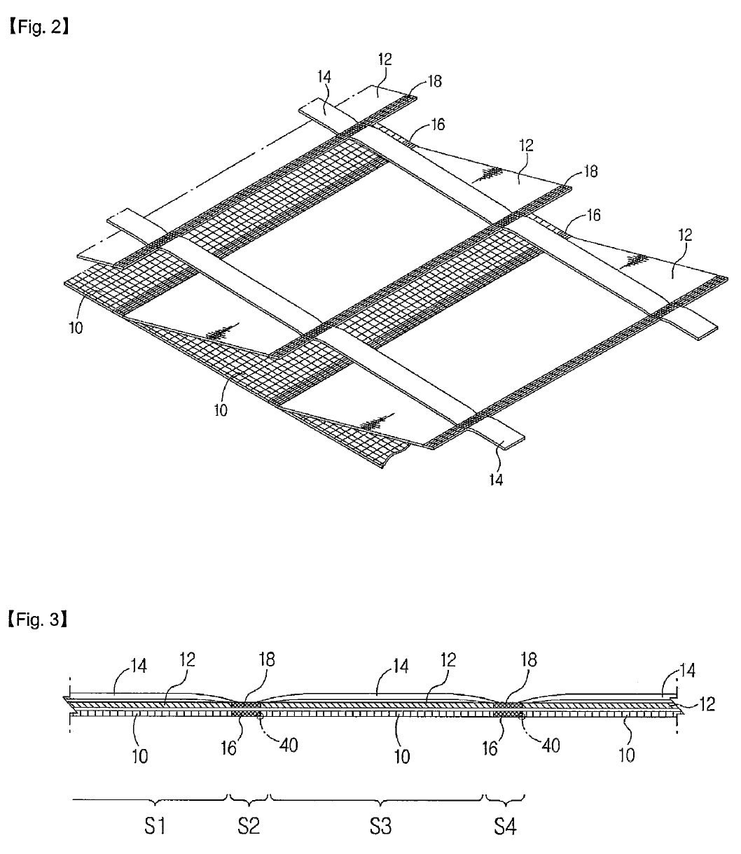

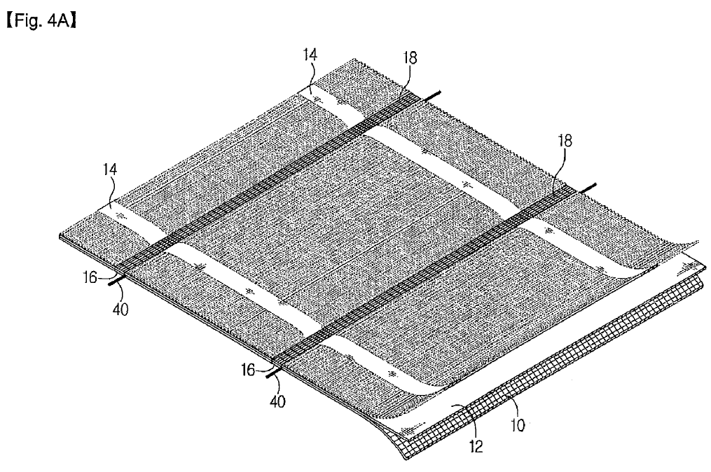

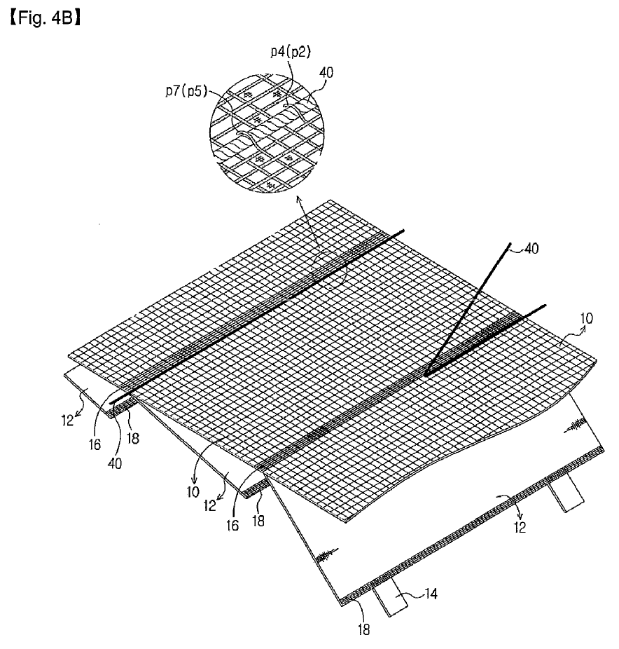

FIG. 1 is a perspective view of a three-dimensional curtain sheet fabric for a window shielding apparatus in accordance with one embodiment of the present invention, FIG. 2 is an expanded perspective view showing a front part's middle of the three-dimensional curtain sheet fabric of FIG. 1, FIG. 3 is a vertical side sectional view of a three-dimensional curtain sheet fabric in accordance with one embodiment of the present invention, and FIG. 4A and 4B are expanded perspective views showing middle parts of front and rear parts before a three-dimensional curtain sheet fabric woven in the triple type in accordance with one embodiment of the present invention is cut by weft shearing and cutting warps.

A three-dimensional curtain sheet fabric 2 in accordance with one embodiment of the present invention is completed by integratedly weaving in the triple type bottom mesh sheets 10, a plurality of awning cover sheets 12, and connection bands 14 for opening and closing the respective awning cover sheets 12.

Like shown in FIG. 1 and FIG. 2, in the present invention, the plurality of awning cover sheets 12 are horizontally arranged on the bottom mesh sheets 10 and accumulated thereon, wherein lower side edges of the respective awning cover sheets 12 are opened, and upper connecting portions 16 thereof are crossly woven with fiber yarns of the bottom mesh sheets 10 positioned at the back whereby the upper connecting portions are integratedly connected with the bottom mesh sheets 10. Then, the awning cover sheets 12 which are horizontally arranged and can be opened to the lower side are connected with the plurality of connection bands 14 arranged on the right and left sides, in the integrated-weaving type via lower connecting portions 18 which are formed on the lower side edges thereof.

LM (Low Melting) yarns are used as warps for forming mesh portions, awning portions, and the connection bands in the three-dimensional curtain sheet fabric 2 of the present invention. A warp supply portion for supplying the warps made of the LM yarns can be configured in the one-beam type or in the two-beam or beam and creel type.

Among warps and wefts that constitute the three-dimensional curtain sheet fabric 2, two kinds of LM yarns of different thicknesses, ATYs (Air Textured Yarns), polyester staple fiber yarns, and compound fiber yarns for cutting can be used as wefts.

Among these wefts, it is desirable that the LM yarns are used alone or in the mixed type as wefts for the upper and lower connecting portions 16 and 18, and it is better that the ATYs are used as wefts for the awning cover sheets 12 and the connection bands 14 and that the ATYs or the polyester staple fiber yarns are used together with the LM yarns when the wefts are mixed for the upper and lower connecting portions 16 and 18. Among the wefts, it is desirable to use the compound fiber yarns as cut yarns 40 applied to cut some warps in order to form a curtain sheet in the three-dimensional type. As another transformed embodiment, it should be understood that the wefts for the connection bands 14 that are exposed to the front can be used by transparent LM yarns like warps instead of the aforementioned opaque ATVs.

The ATYs are fiber yarns made by applying a strong wind to filament yarns to coarsely swell the yarns, and the LM yarns are in sheath and core structure in which external sheath parts are made of low-melting point polyester materials that can be melted at low temperature of approximately 120° C. to 180° C. degrees and deep core parts are made of high-melting point polyester materials. The polyester staple fiber yarns are made of opaque materials, and can be formed in the 20-denier and 3-ply type

It is desirable to use LM yarns of 50 to 100 denier thickness as wefts for the bottom mesh sheets 10 used in the present invention, and it is also recommended that the LM yarns mixed for the upper and lower connecting portions 16 and 18 are 100 to 200 denier in thickness in a different way from the wefts for the bottom mesh sheets 10.

The wefts of the bottom mesh sheet 10 are sparsely woven with the warps which are LM yarns of 50 to 100 denier thickness, forming floodlighting portions of the three-dimensional curtain sheet fabric 2. Since both warps and wefts of the bottom mesh sheets 10 of the three-dimensional curtain sheet fabric 2 for forming floodlighting portions are the LM yarns, the external sheath parts of the LM yarns are bonded together when the heat treatment is applied after the three-dimensional curtain sheet fabric 2 is completely woven. Hence, the warps and the wefts of the woven bottom mesh sheets 10 do not slide, and it is not necessary to perform a special chemical treatment for applying a coating chemical solution to bond the warps and the wefts of the mesh sheets, which was performed in the prior art.

It is desirable to use ATYs of 230 to 430 denier thickness for each weft of the awning cover sheets 12 and the connection bands 14 used in the present invention. The ATYs which are the wefts of the awning cover sheets 12 and the connection bands 14 are densely woven with the warps which are the LM yarns, thereby forming awning portions and band portions of the three-dimensional curtain sheet fabric 2, respectively.

Like in the awning cover sheets 12, the ATYs of 230 to 430 denier thickness can also be used for the wefts of the upper connecting portions 16 which are formed to connect the upper side of the awning cover sheets 12 to the bottom mesh sheets 10. More desirably, the wefts of the upper connecting portions 16 are mixed with the ATYs and 100 to 200 denier of LM yarns. As a specific example, although the ATYs are used for the wefts of the upper connecting portions 16 in most cases, it is better as the LM yarns to use wefts which are just adjacent to the cut yarns 40. It is because when the cut yarns 40 cut the warps (which will be described below) after they are deposited with LM yarns, the adjacent wefts can hold both sides of the cut warps.

Also, in the present invention, it is desirable to use LM yarns as the wefts for the lower connecting portions 18 of the awning cover sheets 12 which are connected and woven with the connection bands 14, and it is more desirable that these LM yarns are 100 to 200 denier in thickness thicker than the wefts of the bottom mesh sheets 10. Furthermore, it is better to mix polyester staple fiber yarns with LM yarns of 100 to 200 denier thickness for the lower connecting portions 18 of the awning cover sheets 12.

Since the connection bands 14 are horizontally spaced from each other at certain intervals when integratedly woven in the triple type, like shown in FIG. 4A, only wefts exist in certain parts where the connection bands 14 are not formed when the weaving process is finished, that is, parts which are not integratedly woven with the warps. In this case, these wefts should be eliminated by shearing.

It is desirable to form the surface width of the connection bands 14 which provide band surfaces, in 1 to 3 cm in order to firmly connect the awning cover sheets 12, and it is recommended to form the spaced intervals of the connection bands 14 to be wider than the surface width of the connection bands 14, for instance, to be at 10 to 20 cm intervals. If the surface width of the connection bands 14 is too wide than a desirable range or the spaced intervals of the connection bands are too narrow than a desirable range, floodlighting portions are hardly formed when the awning cover sheets 12 are opened. And, if the surface width of the connection bands 14 is too narrow than the desirable range or the spaced intervals of the adjacent connection bands 14 are too wide than the desirable range, the connection and the fixation of the awning cover sheets 12 may be unstable or the awning cover sheets 12 may be wrinkled.

Moreover, since the present invention can integratedly weave the three-dimensional curtain by a triple-weaving type only, it is unnecessary to carry out a special shearing process for eliminating externally exposed fiber yarns (warps) which may be created when the awning cover sheets 12 are connected with the bottom mesh sheets 10 in the fourfold or five-layered weaving type and at the same time when the awning cover sheets 12 are coupled with the mesh sheets positioned in front of the cover sheets. Thus, like shown in FIG. 4B, cut yarns 40 for cutting some warps so that the three-dimensional curtain sheet fabric 2 may be unfolded in the stereoscopic type are used with wefts. However, in the present invention, the wefts (see FIG. 4A) formed between the adjacent connection bands 14 are eliminated through the weft shearing when the connection bands are woven.

It is desirable to use compound yarns of 300 to 2000 denier thickness for the cut yarns 40 employed to cut some warps, and further, 800 to 1000 denier thickness would be more desirable. If the cut yarns 40 are in thickness of 300 denier or less, the yarns may be too weak to properly function as cut yarns, and if the thickness of the cut yarns 40 exceeds 2000 denier, the exposed length of the cut warps would get longer as much as the girth of the cut yarns, causing an untidy appearance.

Like FIG. 4A, if unnecessary wefts formed between the connection bands 14 are eliminated through shearing, and like FIG. 4B, if the cut yarns 40 for cutting some warps are pulled to cut the warps by being turned over to the back, the curtain sheet which is in the triple-woven plane state like shown in FIG. 2 is completed as the three-dimensional curtain sheet fabric 2 which is formed in the stereoscopic type.

If the connection bands 14 are slightly pulled up from the three-dimensional curtain sheet fabric 2 configured as above, the lower connecting portions 18 of all of the awning cover sheets 12 which are integratedly woven with the connection bands 14 are lifted up like shown in FIG. 1, whereby floodlighting portions are formed on the three-dimensional curtain sheet fabric 2 as the bottom mesh sheets 10 are exposed, and if the connection bands 14 that are pulled up are lifted down, the lower connecting portions 18 of all of the awning cover sheets 12 are also lifted down, thereby forming awning portions by the awning cover sheets 12 like shown in FIG. 2.

The three-dimensional curtain sheet fabric 2 of the present invention is woven by a rapier loom, and comprises one or two warp supply portions to supply each warp made of LM yarns of 50 to 100 denier thickness. When the two warp supply portions are equipped, a first warp supply portion is configured for forming mesh portions and awning portions of the three-dimensional curtain sheet fabric 2 and a second warp supply portion is configured for forming the connection bands 14.

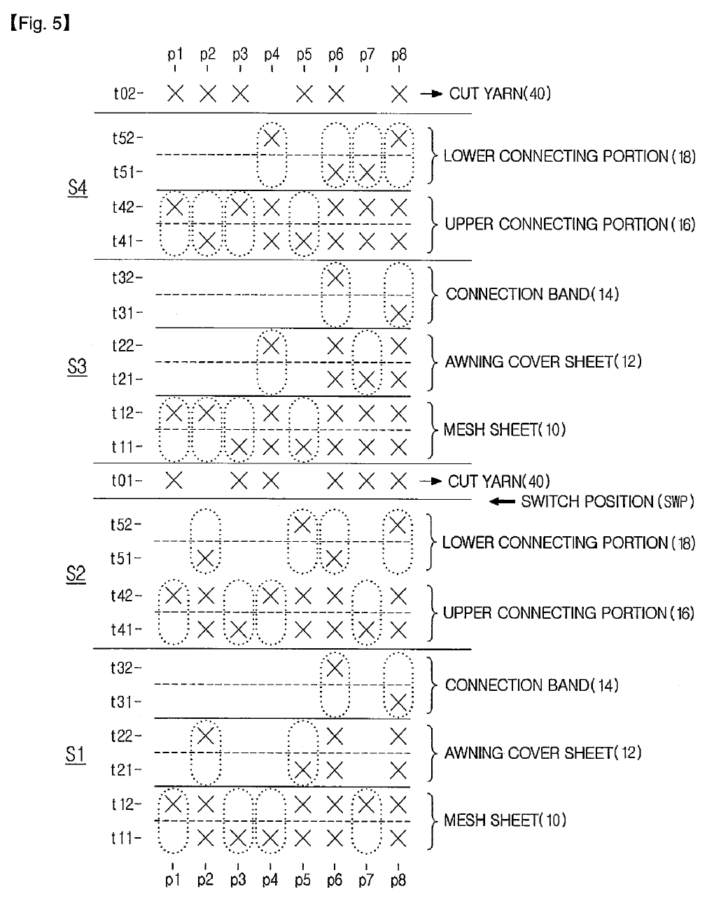

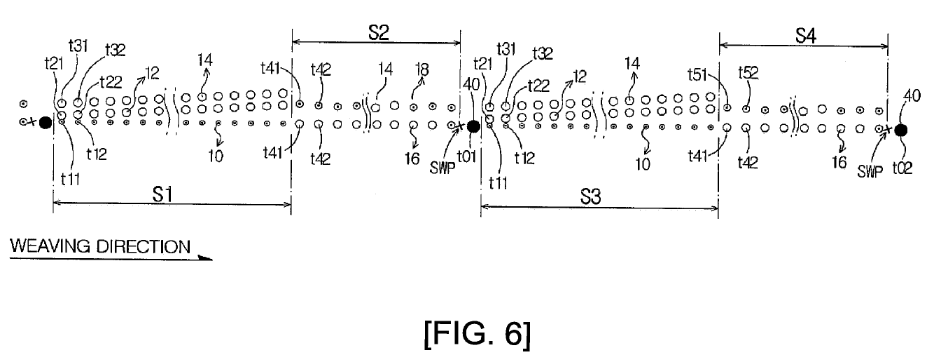

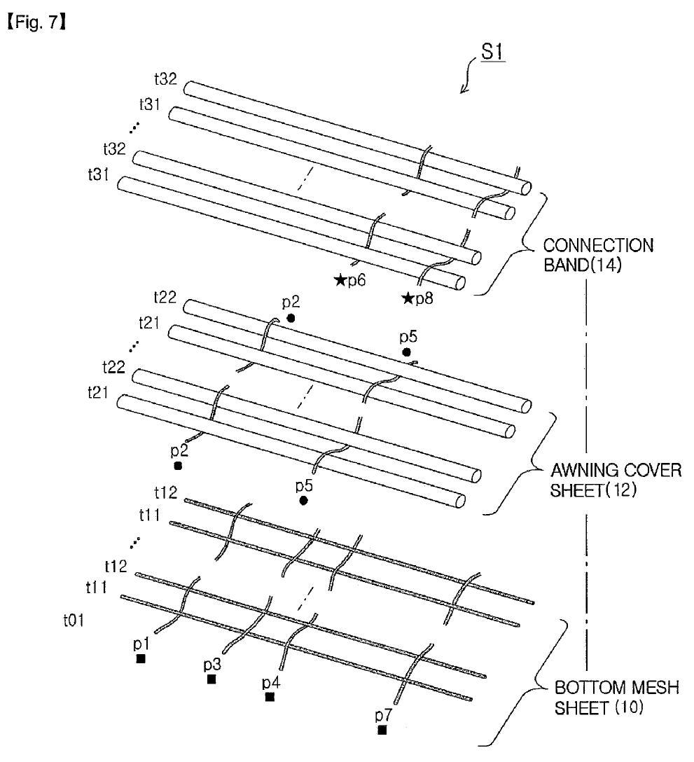

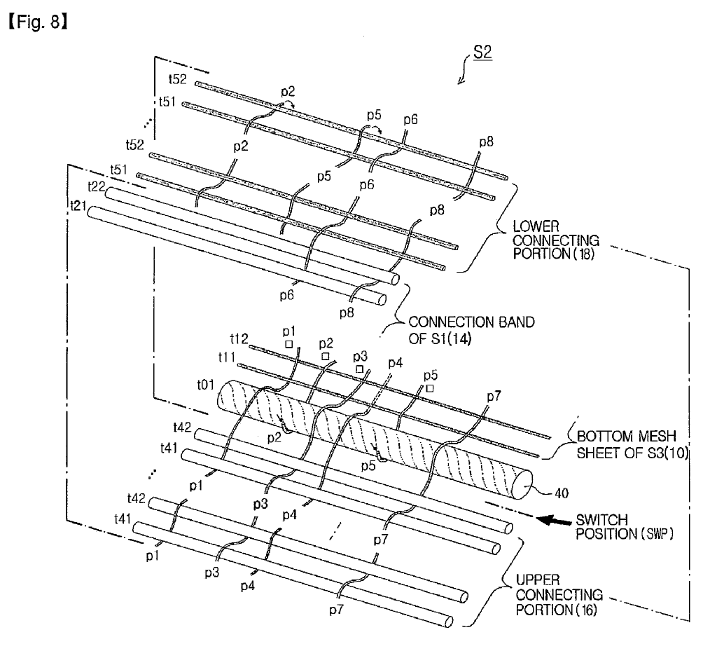

FIG. 5 shows a one-repeat weaving diagram related to main parts of a three-dimensional curtain sheet fabric 2 in accordance with one embodiment of the present invention, FIG. 6 is a diagram for describing a triple-weaving process of the present invention, and FIG. 7 to FIG. 10 are perspective views for describing a triple-weaving process related to sectors S1 to S4 of FIG. 5.

In the weaving diagram of FIG. 5, pi (i is natural number) refers to warps, tj (j is natural number) refers to wefts, and ‘X’ indications mean that the warps are up on the wefts and non-X indications mean that the warps are down on the wefts.

Sectors S1 and S3 correspond to parts in which bottom mesh sheets 10, awning cover sheets 12, and connection bands 14 are independently woven on the three-dimensional curtain sheet fabric 2, and sectors S2 and S4 correspond to parts in which the bottom mesh sheets 10 and the awning cover sheets 12 are woven by connection on the curtain sheet fabric 2 and which the awning cover sheets 12 and the connection bands 14 are woven by connection. And, it should be understood that each sector is woven by continuously repeating a one-repeat weaving process of FIG. 5 tens or dozens of times or more, and that there will be no supply of warps for connection bands in certain parts in which the connection bands 14 do not exist, that is, between the connection bands 14.

Among the warps pi (i=1-8) of the sectors S1 to S4, warps p1-p5 and p7 are provided to form the bottom mesh sheets 10 and the awning cover sheets 12, and p6 and p8 are dedicated warps provided to form the connection bands 14. In the one-repeat weaving diagram of FIG. 5, the horizontal and vertical width between the warps is over 1 mm, and particularly, it should be understood that the weaving diagram of FIG. 5 corresponds to the one-repeat weaving diagram in the parts where the connection bands 14 are formed.

Further, in the sectors S1 to S4, it should be understood that each weft for forming the bottom mesh sheets 10, the awning cover sheets 12, and the connection bands 14 is crossly and continuously injected.

In the present invention, it is definitely not essential to perform a shearing process of weaving the three-dimensional curtain sheet fabric 2 in the triple-weaving type and at the same time cutting some warps after the completion of the weaving process, but a weft shearing process should be carried out in certain parts where the connection bands 14 are not formed.

Further, it should be noted that given that the bottom mesh sheets 10, the awning cover sheets 12, and the connection bands 14 of the sector S1 are primary weaving sections, the bottom mesh sheets 10, the awning cover sheets 12, and the connection bands 14 of the sector S3 correspond to secondary weaving sections positioned under the primary weaving sections after the curtain sheet is installed on the window, and that upper connecting portions 16 of the sector S2 correspond to upper connecting portions of the secondary weaving sections and lower connecting portions 18 of the sector S2 correspond to lower side portions of the awning cover sheets 12 which constitute the primary weaving sections.

Now, a weaving process of the three-dimensional curtain sheet fabric 2 of the present invention will be described in more detail by referring to FIG. 5 to FIG. 10. In the weaving diagram of FIG. 5, the parts in which the warps and the wefts are woven by up and down connections are indicated in dotted circles for the convenience of understanding.

Among the warps p1-p5 and p7 of LM yarns supplied from warp supply portions, p1 and p3 are dedicated warps for mesh sheets only. And, one group of the warps p4 and p7 and the warps p2 and p5 becomes warps that are commonly used for mesh sheets and awning sheets in which the warps of the mesh sheets and the warps of the awning cover sheets are woven by turns in up and down adjacent weaving sections of the currently woven staple. That is to say, the warps p4 and p7 are woven for the mesh sheets while the warps p2 and p5 are for the awning cover sheets in the sector S1, and vice versa in the sector S3. Therefore, the warps p4 and p7 and the warps p2 and p5 are common warps for the mesh sheets and the awning sheets.

Meanwhile, the warps p6 and p8 of the LM yarns supplied from the warp supply portions are woven for the connection bands 14.

In the sector S1, the dedicated warps for the mesh sheets only and the common warps p1, p3, p4 and p7 for both of the mesh sheets and the awning sheets are additionally indicated by “▪” in FIG. 7, and the warps p2 and p5 for the awning cover sheets are additionally indicated by “” in FIG. 7. Besides, the warps p6 and p8 for the connection bands are additionally marked by “★” in FIG. 7.

The sector S1 of FIG. 5 and FIG. 7 refers to a zone where the bottom mesh sheets 10, the awning cover sheets 12, and the connection bands 14 are woven in the triple type.

Referring to both FIG. 5 and FIG. 7, some of the bottom mesh sheets 10 are formed as follows: one pair of warps p4 and p7 (for the mesh sheets in the sector S1) among the dedicated warps p1 and p3 for the mesh sheets only and the common warps for both of the mesh sheets and the awning sheets, which are supplied from first warp supply portions, are woven up and down through warp shedding movements like shown in the weaving diagrams of FIG. 5 and FIG. 7; and the partial bottom mesh sheets are crossly woven with one pair of mesh sheet-used wefts t11 and t12 made by LM yarns of 50 to 100 denier (more desirably, 70 denier) that are sequentially injected right after the up and down movements.

Some of the awning cover sheets 12 are formed as follows: after the one pair of the mesh sheet-used wefts t11 and t12 are sequentially injected, the other pair of the warps p2 and p5 (for the awning sheets in the sector S1) of the common warps for both of the mesh sheets and the awning sheets are woven up and down to form the awning cover sheets 12 through warp shedding movements like shown in the weaving diagrams of FIG. 5 and FIG. 7; and the partial awning cover sheets are formed by a cross weaving process of the warps and the wefts with one pair of awning cover sheet-used wefts t21 and t22 made by ATYs of 230 to 430 denier (more desirably, 330 denier) that are sequentially injected right after the up and down movements. Since the other pair of the warps p2 and p5 of the common warps for both of the mesh sheets and the awning sheets are continuously maintained in the up state without being woven up and down right before the weaving process of the bottom mesh sheets 10, the corresponding pair is not used for the warps for the mesh sheets but used for the awning cover sheets due to the repeated up and down movements during the weaving process of the awning cover sheets 12.

Some of the connection bands 14 are formed as follows: after some of the awning cover sheets 12 are woven, the dedicated warps p6 and p8 for the connection bands are woven up and down to form the connection bands 14 like shown in the weaving diagrams of FIG. 5 and FIG. 7; and the partial connection bands are formed by a cross weaving process of the warps and the wefts with one pair of connection band-used wefts t31 and t32 that are sequentially injected right after the up and down movements. Since the dedicated warps p6 and p8 for the connection bands are continuously maintained in the up state without being woven up and down right before the weaving process of the bottom mesh sheets 10, the corresponding warps are not used for the mesh sheets and the awning cover sheets but used for the connection bands 14 because they are woven up and down during the weaving process of the connection bands 14.

The aforementioned injection of the wefts is sequentially repeated one pair by one pair in the following order of the wefts t11 and t12 for the mesh sheets, the wefts t21 and t22 for the awning cover sheets, and the wefts t31 and t32 for the connection bands, and right before each one pair of the wefts is injected, the warp shedding movements are continuously performed like shown in the weaving diagram of FIG. 5 whereby the bottom mesh sheets 10, the awning cover sheets 12, and the connection bands 14 are respectively woven through the cross weaving process of the warps and the wefts like shown in FIG. 7 in the weaving direction of FIG. 6. The corresponding sectors S1 to S4 of FIG. 5 and FIG. 6 are also indicated in the vertical side sectional view of FIG. 3.

Among the symbol indications of wefts of FIG. 6, “∘” refers to ATYs, and “⊙” refers to LM yarns. “∘” expressed together with the LM yarns “⊙” in the lower connecting portions 18 that cover the top of the upper connecting portions 16 corresponds polyester staple fiber yarns (or ATYs).

The awning cover sheets 12 and the connection bands 14 in the sector S1 are woven with the bottom mesh sheets 10 at the same time.

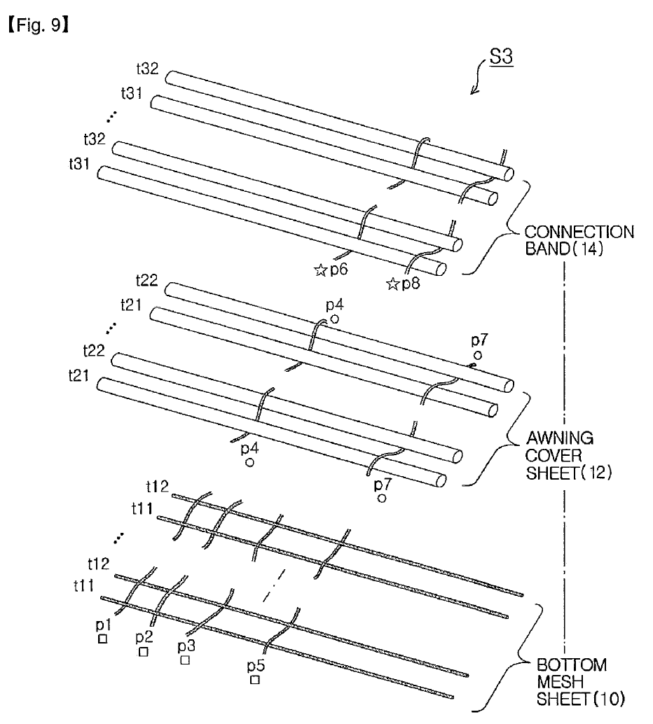

Next, the sector S2 illustrated in FIG. 5 and FIG. 8 refers to a zone for weaving the rear-positioned upper connecting portions 16 for connecting the awning cover sheets 12 and the bottom mesh sheets 10 of the secondary weaving sections and at the same time a zone for weaving the front-positioned lower connecting portions 18 for connecting the connection bands 14 and lower side edges of the awning cover sheets 12 of the previous primary weaving sections.

Referring to both of FIG. 5 and FIG. 8, some of the rear-positioned upper connecting portions 16 for connecting the awning cover sheets 12 and the bottom mesh sheets 10 of the sector S2 are formed as follows: one pair of wefts t41 and t42 mixed with LM yarns and ATYs are sequentially injected; and the wefts t41 and t42 are crossly woven with one pair of common warps p4 and p7 (for the mesh sheets in the sector S1) among the dedicated warps p1 and p3 for the mesh sheets only and the common warps for both of the mesh sheets and the awning sheets. The LM yarns of 100 to 200 denier thickness (more desirably, 150 denier thickness) mixed with the wefts t41 and t42 are relatively thicker than the LM yarns of 50 to 100 denier thickness used for the warps or the wefts for the mesh sheets.

To form the front-positioned lower connecting portions 18 after some of the rear-positioned upper connecting portions 16 of the sector S2 are woven, some of the front-positioned lower connecting portions 18 positioned on the lower side edges of the awning cover sheets 12 are formed as follows: the other pair of the warps p2 and p5 (for the awning sheets in the sector S1) of the common warps for both of the mesh sheets and the awning sheets and the dedicated warps p6 and p8 for the connection bands only are woven up and down through warp shedding movements like shown in the weaving diagrams of FIG. 5 and FIG. 8; and the weaving process of the warps and the wefts is performed with one pair of wefts t51 and t52 that are sequentially injected right after the up and down movements. Since the front-positioned lower connecting portions 18 are woven with the wefts by the warps p6 and p8 used for the connection bands and the warps p2 and p5 used for the awning sheets in the primary weaving sections, the awning cover sheets 12 and the connection bands 14 are naturally woven and connected on the lower side edges of the awning cover sheets 12. LM yarns are mainly used for the wefts t51 and t52 that are injected to the front-positioned lower connecting portions 18, and polyester staple fiber yarns are mixed therein.

The aforementioned injection of the wefts is sequentially repeated one pair by one pair in the following order of the wefts t41 and t42 and the wefts t51 and t52, and right before each one pair of the wefts is injected, the warp shedding movements are continuously performed like shown in the weaving diagram of the sector S2 of FIG. 5 whereby the lower connecting portions 18 of the front-positioned awning cover sheets 12 as well as the upper connecting portions 16 of the rear-positioned awning cover sheets 12 are respectively woven through the cross weaving process of the warps and the wefts like shown in FIG. 8 in the weaving direction of FIG. 6.

After the weaving process in the sector S2 is completed, before starting to weave the bottom mesh sheets 10 of the sector S3, the cut yarns 40 are injected as wefts t0 by cutting the warps p2 and p5 which alternately become the warps for the awning cover sheets 12 in the primary weaving sections and the warps for the bottom mesh sheets 10 in the secondary weaving sections of the section S3. Right before the cut yarns 40 are injected as the wefts t0, the warps p1, p3-p4 and p6-p8 are woven up while the warps p2 and p5 are woven down through warp shedding movements like shown in the weaving diagrams of FIG. 5 and FIG. 8.

That is to say, the weft-injected position at which the cut yarns 40 are injected as the wefts t0 is located between first wefts (t11) of the bottom mesh sheets 10 of the sector S3 and final wefts (t42) of the rear-positioned upper connecting portions 16 within the sector S2, and the corresponding position becomes a warp-role switch position (SWP). At the corresponding warp-role switch position (SWP), as the one pair of the warps p4 and p7 (for the mesh sheets in the sector S1) of the common warps for both of the mesh sheets and the awning sheets and the other pair of the warps p2 and p5 (for the awning sheets in the sector S1) of the common warps for both of the mesh sheets and the awning sheets switch their roles, the awning cover sheets 12 and the bottom mesh sheets 10 of the secondary weaving sections are connected together.

Although the weft-injected position at which the cut yarns 40 are injected as the wefts t0 is desirably between the first wefts (t11) of the bottom mesh sheets 10 of the sector S3 and the final wefts (t42) of the upper connecting portions 16, it should be understood that the present invention is not limited to this configuration. That is to say, it would be desirable once the weft-injected position at which the cut yarns 40 are injected as the wefts t0 is located in the vicinity between the upper connecting portions 16 and the bottom mesh sheets 10. For example, the corresponding position may be formed on the upper connecting portions 16 or on the bottom mesh sheets 10 near to the upper connecting portions 16.

The sector S3 illustrated in FIG. 5 and FIG. 9 refers to a zone where the bottom mesh sheets 10, the awning cover sheets 12, and the connection bands 14 of the secondary weaving sections are simultaneously woven in the triple type, and the sector S4 refers to a zone for simultaneously weaving the rear-positioned upper connecting portions for connecting the bottom mesh sheets 10 and the awning cover sheets 12 of third-time weaving sections as well as the front-positioned lower connecting portions 18 for connecting the connection bands 14 and the awning cover sheets 12 of the secondary weaving sections.

The triple-weaving type in the sector S3 is almost similar to the weaving process in the sector S1, and the differences are as follows: the one pair of the warps p4 and p7 (for the mesh sheets in the sector S1) of the common warps for both of the mesh sheets and the awning sheets in the sector S1 become the warps for the awning sheets in the sector S3, and further, the other pair of the warps p2 and p5 (for the awning sheets in the sector S1) of the common warps for both of the mesh sheets and the awning sheets become the warps for the mesh sheets in the sector S3.

Hence, the warps for the mesh sheets in the sector S3 correspond to the dedicated warps p1 and p3 for the mesh sheets only and the other pair of the warps p2 and p5 (for the awing sheets in the sector S1) of the common warps (p4, p7) (p2, p5) for both of the mesh sheets and the awning sheets, and are additionally marked by “□” in FIG. 9. Also, the warps for the awning sheets in the sector S3 correspond to the one pair of the warps p4 and p7 (for the mesh sheets in the sector S1) of the common warps (p4, p7) (p2, p5) for both of the mesh sheets and the awning sheets, and are additionally marked by “∘” in FIG. 9. The warps p6 and p8 for the connection bands in the sector S3 are the same as those of the connection bands in the sector S1, and are additionally marked by “⋆”.

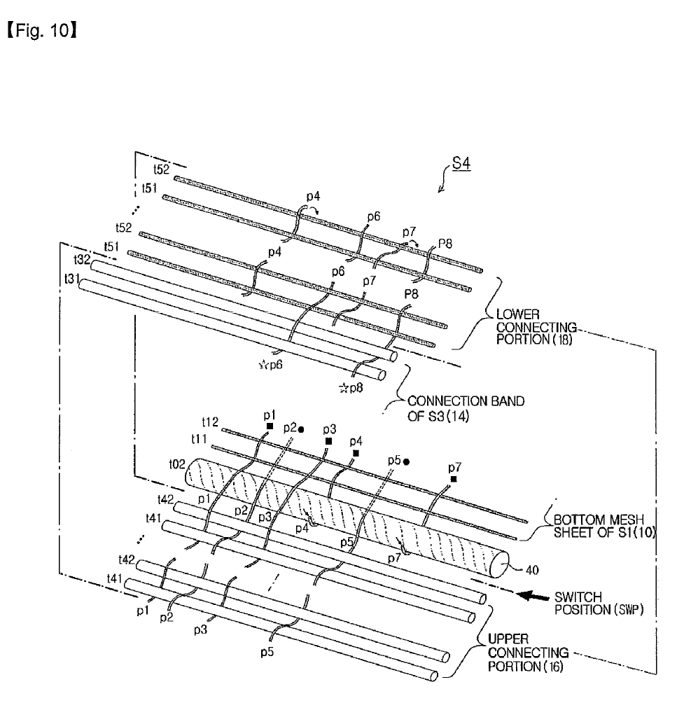

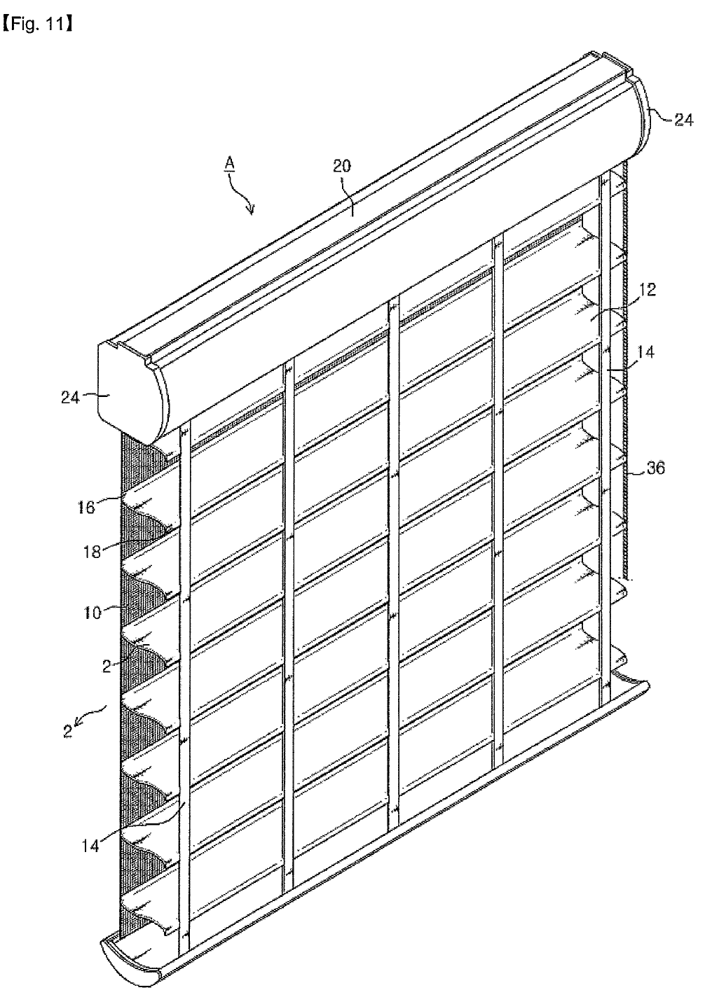

Further, although a double weaving process in the sector S4 is almost similar to that in the sector S2, the only difference is as follows: like shown in FIG. 5 and FIG. 10, the warps of the rear-sided upper connecting portions 16 consist of the dedicated warps p1 and p3 for the mesh sheets only and the warps p2 and p5 which are used for the mesh sheets in the secondary weaving sections; and the warps of the upper-sided lower connecting portions 18 consist of the dedicated warps p6 and p8 for the connection bands only and the warps p4 and p7 which are used for the awning sheets in the secondary weaving sections.

Then, after the weaving process in the sector S4 is finished, the cut yarns 40 are injected as wefts t1 by cutting the warps p4 and p7 which alternately become the warps of the bottom mesh sheets 10 in fourfold weaving sections of the sector S1 as well as become the warps of the awning cover sheets 12 of the secondary weaving sections, before the bottom mesh sheets 10 of the sector S1 start to be woven again. Right before the cut yarns 40 are injected as the wefts t1, the warps p1-p3, p5-p6 and p8 are woven up and the warps p4 and p7 are down through warp shedding movements like shown in the weaving diagrams of FIG. 5 and FIG. 10.

That is to say, the weft-injected position at which the cut yarns 40 are injected as the wefts t1 is located between first wefts (t11) of the bottom mesh sheets 10 of the sector S1 and final wefts (t42) of the rear-sided upper connecting portions 16 within the sector S4, and the corresponding position becomes a warp-role switch position (SWP). At the warp-role switch position (SWP), the other pair of the warps p2 and p5 (for the mesh sheets in the sector S3) of the common warps for both of the mesh sheets and the awning sheets and the other pair of the warps p4 and p7 (for the awning sheets in the sector S3) of the common warps for both of the mesh sheets and the awning sheets alternately switch their roles, so that the awning cover sheets 12 and the bottom mesh sheets of the next third-time weaving sections may be connected together.

Although the weft-injected position at which the cut yarns 40 are injected as the wefts t1 is desirably between the first wefts (t11) of the bottom mesh sheets 10 of the sector S1 and the final wefts (t42) of the rear-sided connecting portions 16, it should be understood that the present invention is not limited to this configuration. That is to say, it would be desirable once the weft-injected position at which the cut yarns 40 are injected as the wefts t1 is located in the vicinity between the upper connecting portions 16 and the bottom mesh sheets 10. For example, the corresponding position may be formed on the upper connecting portions 16 or on the bottom mesh sheets 10 near to the upper connecting portions 16.

The warps p2 and p5 woven down on the wefts t0 of the cut yarns 40 and the warps p4 and p7 woven down on the wefts t1 of the cut yarns 40, which are shown in FIG. 8, correspond to the warps for the lower connecting portions 18 of the awning sheets in the previous weaving sections and to the one pair of the warps for the bottom mesh sheets 10 in the next weaving sections, respectively. Thus, if the cut yarns 40 are pulled and removed like shown in FIG. 4B while the three-dimensional curtain sheet fabric 2 is put upside down after the curtain sheet is completely woven, the corresponding warps p2 and p5 or p4 and p7 are cut whereby the lower connecting portions 18 of the awning cover sheets 12 are separably opened from the bottom mesh sheets 10.

Through the above weaving process of repeating the sectors S1 to S4, the three-dimensional curtain sheet fabric 2 is woven in a lump in the plane type, then the mesh sheets are thermally treated with no need to perform any chemical solution applying treatment for bonding the mesh sheets together.

Once the heat treatment is applied to the three-dimensional curtain sheet fabric 2, the warps and the wefts made of the LM yarns are thermally bonded together by a melting process thereby preventing them from being slipped on the bottom mesh sheets 10, and the warps and the wefts of the rear-sided upper connecting portions 16 and the front-sided lower connecting portions 18 where wefts of thicker LM yarns than the LM yarns of the warps are included are thermally bonded by a melting process, so that the connecting portions are more firmly bonded and fixed.

After the heat treatment is applied like above, the wefts positioned between the connection bands 16 that are unnecessarily located on the front side of the three-dimensional curtain sheet fabric 2 like shown in FIG. 4A are sheared and eliminated, then like shown in FIG. 4B, once the three-dimensional curtain sheet fabric 2 is turned over to pull the cut yarns 40 located on the rear side, the warp pairs p2 and p5 or p4 and p7 for connecting the bottom mesh sheets 10 and the lower side edges of the awning cover sheets 12 are cut, thereby separably opening the lower connecting portions 18 of the awning cover sheets 12 from the bottom mesh sheets 10.

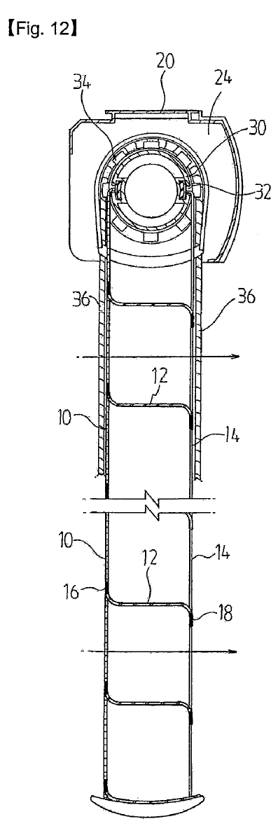

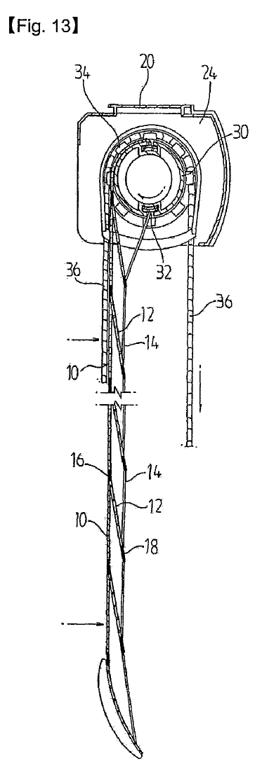

FIG. 11 is a perspective view of a window shielding apparatus having a three-dimensional curtain sheet fabric in accordance with one embodiment of the present invention, and FIG. 12 and FIG. 13 are side sectional views of FIG. 11.

A three-dimensional curtain sheet fabric 2 woven in the triple type according to the present invention is coupled and fixed to a horizontal slit coupling groove of a driving axial bar 30 that is axially rotated between both brackets 24 of a frame 20 of a window shielding apparatus A like shown in FIG. 11. Bottom mesh sheets 10 and awning cover sheets 12 of the curtain sheet fabric 2 are inserted and fixed toward the rear side of the horizontal slit coupling groove 32, and connection bands 14 are inserted and fixed toward the front side of the horizontal slit coupling groove 32 in order to be coupled and fixed thereto. Then, lift controlling strings 36 are engaged with a chain wheel 34 coupled with one side end of the driving axial bar 30 to make the curtain sheet fabric 2 rise up and down once the user pulls the lift controlling strings 36. For example, if the user pulls a rear string of the lift controlling strings 36, the three-dimensional curtain sheet fabric 2 is unfastened from the rotating driving axial bar 30 and lifted down, but if the user pulls a front string of the lift controlling strings 36, the three-dimensional curtain sheet fabric 2 is lifted up as being wound on the driving axial bar 30 which rotates reversely.

If the rear string of the lift controlling strings 36 is further pulled in a state of the three-dimensional curtain sheet fabric 2 being fully lifted down, the connection bands 14 lift up lower connecting portions 18 of all of the awning cover sheets 12 as the awning cover sheets 12 and the bottom mesh sheets 10 coupled with the driving axial bar 30 move to the rear side while at the same time the connection bands 14 coupled with the driving axial bar 30 move to the front side, like shown in a side sectional view of FIG. 12. Accordingly, as the bottom mesh sheets 10 hidden by the awning cover sheets 12 are exposed, floodlighting portions are formed on the three-dimensional curtain sheet fabric 2.

Likewise, if the front string of the lift controlling strings 36 is slightly pulled in a state of the floodlighting portions being formed on the three-dimensional curtain sheet fabric 2, the connection bands 14 release the lower connecting portions 18 of all of the awning cover sheets 12 as the awning cover sheets 12 and the bottom mesh sheets 10 coupled with the driving axial bar 30 move to the upper side while at the same time the connection bands 14 coupled with the driving axial bar 30 move to the lower side, like shown in FIG. 13, whereby the awning cover sheets 12 are closed to the bottom. Accordingly, the floodlighting portions of the bottom mesh sheets 10 are covered by the awning cover sheets 12 and converted into awning portions.

The window shielding apparatus A having the three-dimensional curtain sheet fabric 2 in accordance with one embodiment of the present invention shows good ventilation and floodlighting effects once the connection bands 14 that are sparsely isolated from the bottom mesh sheets 10 are equipped during the formation of the floodlighting portions, and because the connection bands 14 firmly connect and fix the awning cover sheets, the invention realizes strong durability with almost no transformation of a shape even though the user strongly pulls the awning cover sheets 12 or the connection bands 14.

FIG. 24 is a perspective view of a window shielding apparatus having a three-dimensional curtain sheet fabric 2a transformed from the three-dimensional curtain sheet fabric 2 of FIG. 11, according to one embodiment of the present invention.

The three-dimensional curtain sheet fabric 2a of FIG. 24 which constitutes the window shielding apparatus A has several times wider upper and lower widths than the awning cover sheets 12 of the three-dimensional curtain sheet fabric 2 in accordance with one embodiment of the present invention. More specifically, the upper and lower widths of the awning cover sheets 12 are much wider than the diameter of the driving axial bar 30.

Therefore, the three-dimensional curtain sheet fabric 2a of FIG. 24 can show the effect of opening the curtain about in half even though the awning cover sheets 12 are sufficiently pulled up open by the connection bands 14, giving a decorative beauty in accordance with the formation of a side U-shaped curve of the awning cover sheets 12.

Next, an integrated-weaving type three-dimensional curtain sheet fabric having front and rear connection bands in accordance with another embodiment of the present invention will be described in reference to FIG. 14 to FIG. 23.

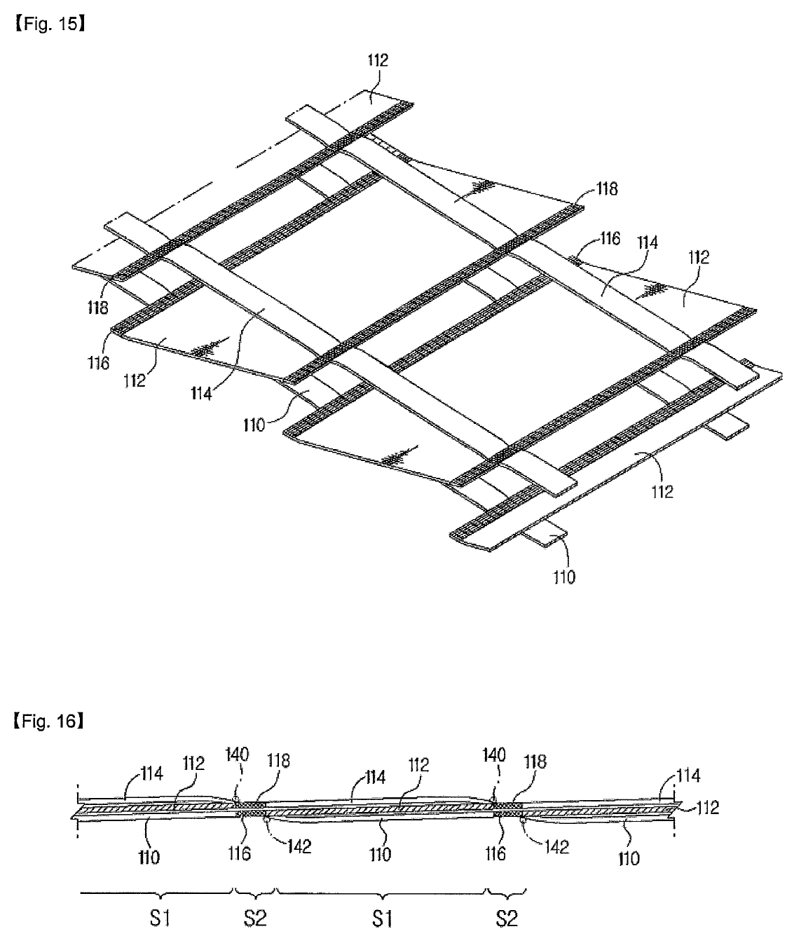

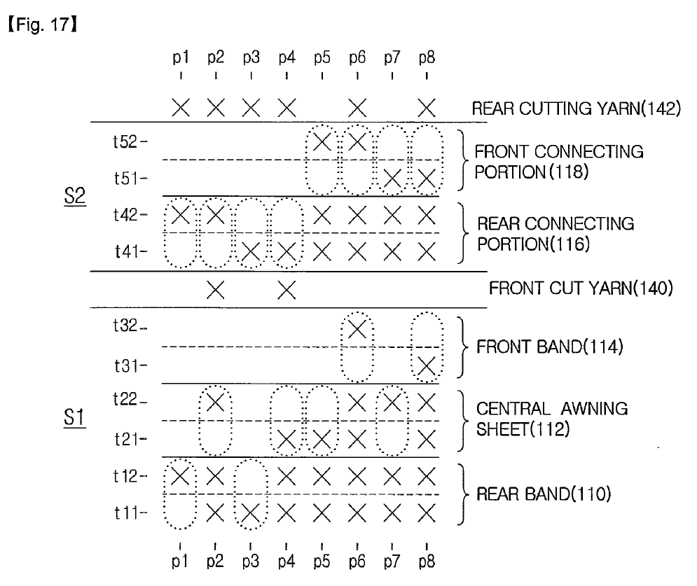

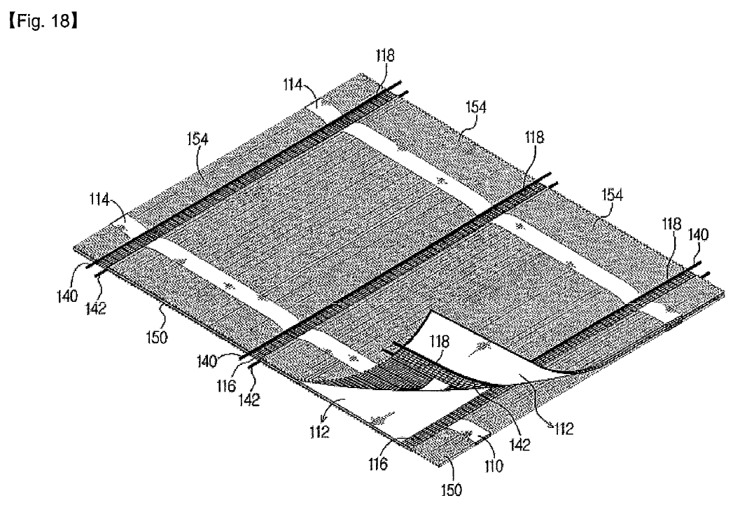

FIG. 14 is a perspective view of a three-dimensional curtain sheet fabric for a window shielding apparatus in accordance with another embodiment of the present invention, FIG. 15 is an expanded perspective view showing a middle part of the three-dimensional curtain sheet fabric of FIG. 14, FIG. 16 is a side sectional view of a three-dimensional curtain sheet fabric in accordance with another embodiment of the present invention, FIG. 17 is a one-repeat weaving diagram related to main parts of a three-dimensional curtain sheet fabric in accordance with another embodiment of the present invention, and FIG. 18 is a weaving perspective view before a three-dimensional curtain sheet fabric woven in the triple type according to another embodiment of the present invention is cut by front and rear weft shearing and cutting warps.

A three-dimensional curtain sheet fabric 200 in accordance with the embodiment of the present invention is completed by integratedly triple-weaving front and rear bands 114 which are arranged right and left and extended in the up and down direction on each of the front and rear sides of central awning sheets 112 that are horizontally extended and arrayed up and down, with fiber yarns.

Like shown in FIG. 14 and FIG. 15, the central awning sheets 112 and rear bands 110 are connected through the integrated weaving via rear-positioned connecting portions 116 which are located on upper side edges of the central awning sheets 112, and the central awning sheets 112 and front bands 114 are connected through the integrated weaving via front-positioned connecting portions 118 which are located on lower side edges of the central awning sheets 112.

The three-dimensional curtain sheet fabric 200 of the present invention is woven by a rapier loom, and it is desirable to use LM yarns as warps for forming the central awning sheets 112 and the front and rear bands 114 and 110 together with various kinds of wefts such as LM yarns, ATYs, polyester staple fiber yarns, and compound fiber yarns for cutting.

A warp supply portion for supplying the warps made of the LM yarns can be configured in the one-beam type or in the two-beam or beam and creel type.

Among the wefts, it is desirable to use the LM yarns as the wefts for the front and rear connecting portions 118 and 116, taken alone or in combination. And, it is better to use the ATYs as the wefts for the central awning sheets 112 and the front and rear bands 114 and 110, and to use the polyester staple fiber yarns together with the LM yarns when mixed with the wefts in the front and rear connecting portions 118 and 116. Among the wefts, it is desirable to use the compound fiber yarns as cut yarns 140 and 142 that are used to cut some warps in order to form the curtain sheet in the three-dimensional type. As another transformed example, it should also be understood that the front and rear bands 114 and 110 can use transparent LM yarns instead of the aforementioned opaque ATYs.

It is desirable that the LM yarns used alone or in combination for the front and rear connecting portions 118 and 116 of the present invention are 100 to 200 denier of thickness, and if the wefts for the front and rear bands 114 and 110 employ the transparent LM yarns instead of the opaque ATYs, it is better that the corresponding wefts are 50 to 100 denier of thickness. If all of the warps and the wefts of the front and rear bands 114 and 110 use the LM yarns, the front and rear bands 114 and 110 can function as floodlighting portions as well as the connection bands. However, in this case, the tensile strength may slightly be weakened compared to the ATYs.

When the front and rear connecting portions 118 and 116 of the three-dimensional curtain sheet fabric 200 on which the warps and the wefts are woven together by the LM yarns are thermally treated after the three-dimensional curtain sheet fabric is completely woven, the external sheath parts of the LM yarns are bonded together. Hence, the warps and the wefts which are crossly woven do not slide, and it is not necessary to perform a special chemical treatment for applying a coating chemical solution to bond the warps and the wefts of the mesh sheets, which was performed in the prior art.

It is desirable to use ATYs of 230 to 430 denier thickness for each weft of the central awning sheets 112 and the front and rear bands 114 and 110 used in the present invention. The ATYs which are the wefts of the central awning sheets 112 and the front and rear bands 114 and 110 are densely woven with the warps which are the LM yarns, thereby forming awning portions and band portions of the three-dimensional curtain sheet fabric 200, respectively.

And, it is desirable to mix the polyester staple fiber yarns or the ATYs with the LM yarns for the wefts of the rear connecting portions 116 that connect upper side edges of the central awning sheets 112 with the rear bands 110 and for the wefts of the front connecting portions 118 that connect lower side edges of the central awning sheets 112 with the front bands 114. As a specific example, it is better to mainly use the polyester staple fiber yarns or the ATYs as the wefts for the middle side of the front and rear connecting portions 118 and 116, and to use the LM yarns as the wefts for the outer side of the front and rear connecting portions 118 and 116 on which cut yarns 140 and 142 are put. It is because when the front and rear cut yarns 140 and 142 cut some warps for the central awning sheets in order to form the three-dimensional curtain after being melted by the LM yarns, both sides of the cut warps can be fixed through a bonding process.

Since the front and rear bands 114 and 110 are formed at certain right and left intervals when integratedly woven in the triple type, only shearing target wefts 154 and 150 exist on the front and rear sides in certain parts where the front and rear bands 114 and 110 are not formed, that is, parts where the integrated weaving process is not performed with the warps, like shown in FIG. 18. These wefts 154 and 150 are eliminated through shearing after the weaving process is finished.

The front and rear bands 114 and 110 are formed in the front and rear direction side by side, and it is desirable to set the width of the bands in 1 to 3 cm so that the bands can firmly connect the central awning sheets 112. In addition, it is desirable to form the intervals between the front bands 114 and between the rear bands 110 to be wider than the width of the front and rear bands 114 and 110, for example, to be at intervals of 10 to 20 cm. If the width of the front and rear bands 114 and 110 is set to be much wider than the desirable range or the intervals between the front bands 114 and between the rear bands 110 are set to be much narrower than the desirable range, floodlighting portions are hardly formed when the central awning sheets 112 are opened. And, if the width of the front and rear bands 114 and 110 is much narrower than the desirable range or the intervals between the front bands 114 and between the rear bands 110 are much wider than the desirable range, connection and fixation of the central awning sheets 112 may be unstable or the central awning sheets 112 can be wrinkled.

Further, in the present invention, because the three-dimensional curtain can integratedly be woven even in the triple type only when general front and back mesh sheets and the central awning sheets are connected together, it is not required to perform a special shearing process of removing fiber yarns (warps) to be exposed to the outside. For instance, in general, when the curtain is integratedly woven and folded in three, it should be woven in the fourfold or five-layered type including certain parts which should be sheared.

However, even with the triple-weaving type only, the present invention can use the wefts with the cut yarns 140 and 142 for cutting some warps in order to unfold the three-dimensional curtain sheet fabric 200 in the three-dimensional type like shown in FIG. 14 and FIG. 15. But, in the present invention, wefts 154 and 150 (see FIG. 18) formed between the adjacent front bands 114 and between the adjacent rear bands 110 should be eliminated by shearing while the front and rear bands 114 and 110 are woven.

It is desirable to use compound yarns of 300 to 2000 denier thickness as the cut yarns 140 and 142 which are used to cut some warps, and 800 to 1000 denier thickness would be more desirable. If the thickness of the cut yarns 140 and 142 is 300 denier or less, the cut yarns are unable to function properly due to weakened yarns, and if the thickness of the cut yarns 140 and 142 exceeds 2000 denier, the exposed length of the cut warps would get longer as much as the girth of the cut yarns, causing an untidy appearance.

Like shown in FIG. 18, after the unnecessary wefts 154 formed between the adjacent front bands 14 are eliminated through shearing and turned over to the back to remove the unnecessary wefts 150 formed between the rear bands 110 through shearing, if the warp-cutting cut yarns 140 and 142 positioned on the front and the back are pulled to cut some warps, the three-dimensional curtain sheet fabric 200 which is woven in the triple type like shown in FIG. 14 and FIG. 15 is completed.

In the three-dimensional curtain sheet fabric 200 having the aforementioned front and rear bands 114 and 110, if the front bands 114 are slightly pulled up, the front connecting portions 118 of the lower side edges of all of the awning sheets 112 that are integratedly woven with the front bands 114 are lifted up like shown in FIG. 14, thereby forming floodlighting portions which are pierced back and forth on the three-dimensional curtain sheet fabric 200. And, if the front bands 114 which are pulled up are lifted down, the front connecting portions 118 of the lower side edges of all of the awning sheets 112 are lifted down to form awning portions by the awning sheets 112 like shown in FIG. 15.

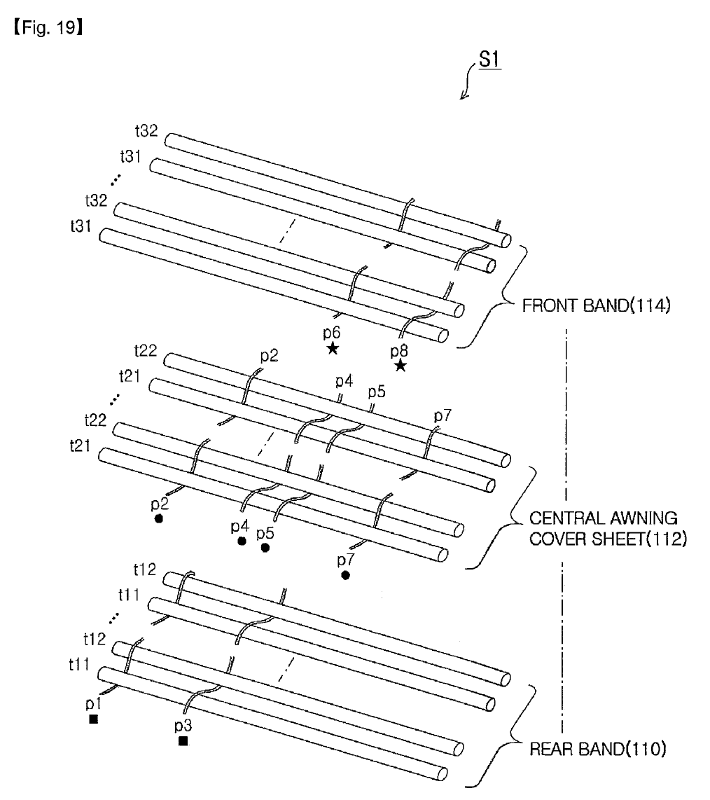

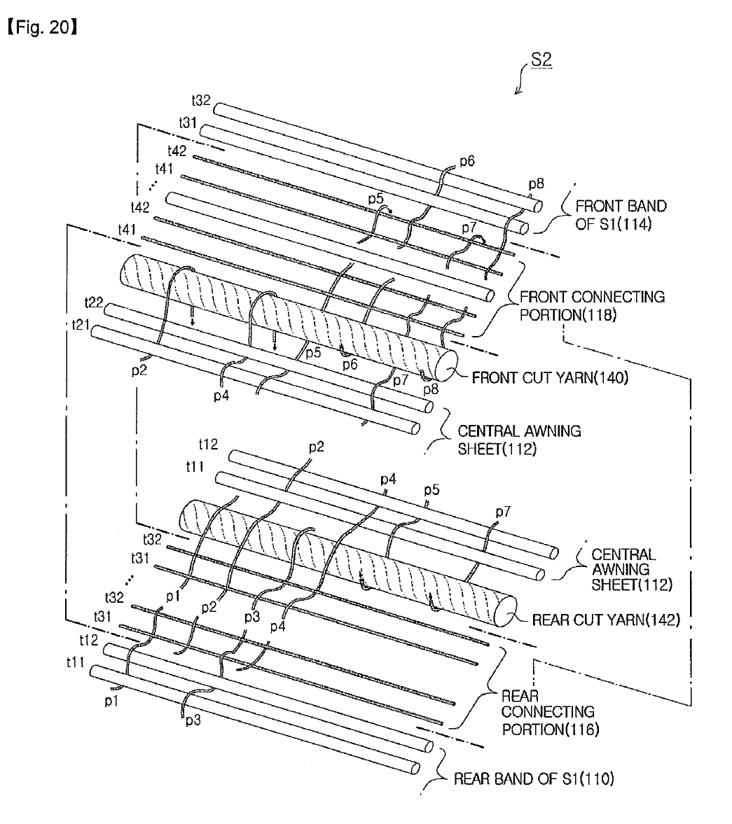

The one-repeat weaving diagram related to the main parts of the three-dimensional curtain sheet fabric 200 illustrated in FIG. 17 is in the triple-woven type like shown in the perspective views on the weaving processes of FIG. 19 and FIG. 20.

In FIG. 17, FIG. 18 and FIG. 19, pi (i is natural number) refers to warps, tj (j is natural number) refers to wefts, and ‘X’ indications shown at tables of FIG. 17 mean that the warps are up on the wefts and non-X indications shown at the tables of FIG. 17 mean that the warps are down on the wefts.

A sector S1 corresponds to a part in which the central awning sheets 112 and the front and rear bands 114 and 110 are independently woven on the three-dimensional curtain sheet fabric 200, and a sector S2 corresponds to a part in which the central awning sheets 112 are bonded and connected with the rear bands 110 and the front bands 114. And, it should be understood that the corresponding parts are woven by continuously repeating a one-repeat weaving process of FIG. 17 in each sector tens or dozens of times or more, and that there will be no supply of warps in certain parts in which the front and rear bands 114 and 110 do not exist.

Among the warps pi (=1˜8) of the sectors S1 to S4, the warps {p1,p3} are mainly used for the formation of the rear bands 110 while the warps {p2,p5} {p4,p7} are mainly used for the formation of the central awning sheets 112, and the warps {p6,p8} are mainly for the front bands 114. In the one-repeat weaving diagram, the right and left widths between the warps are over 1 mm and it should be understood that the one-repeat weaving diagram shows the part where the front and rear bands 114 and 110 are formed.

Further, it should be noted that in the sectors S1 and S2, each weft for the formation of the awning sheets 112 and the front and rear bands 114 and 110 has to be continuously and crossly injected through rapiers of a rapier loom.

In the present invention, it is definitely unnecessary to perform a shearing process of cutting some warps when the three-dimensional curtain sheet fabric 200 is woven in the triple type and at the same time after the weaving process is finished, but a weft shearing process should be carried out in the part where the front and rear bands 114 and 110 are not formed.

Now, a weaving process of the three-dimensional curtain sheet fabric 200 of the present invention will be described in more detail by referring to FIG. 16 to FIG. 19. It should be understood that in the following preferred embodiment of the present invention, the wefts of the front bands 114 and the rear bands 110 will be described by using ATYs made of the same wefts as the awning sheets, and that in FIG. 17, the parts where the warps and the wefts are connected and woven up and down are marked in the dotted line.

In a sector S1 of FIG. 19, warps {p1,p3} for the rear bands 110 are additionally indicated by “▪”, warps {p2,p5} {p4,p7} for the central awning sheets 112 are by “”, and warps {p6,p8} for the front bands 114 are by “★”. Here, the “{ }” marks mean pairs of the warps which are involved in the weaving of the awning sheets or the front and rear bands.

The sector S1 of FIG. 17 refers to a zone where the rear bands 110, the central awning sheets 112, and the front bands 114 are woven in the triple type, and the sector S2 refers to a zone where the rear connecting portions 116 and the front connecting portions 118 are woven in the double type. At this time, it should be noted that the front connecting portions 118 in the sector S2 correspond to lower side edge parts of the central awning sheets 112 which are currently woven and the rear connecting portions 116 in the sector S2 correspond to upper side edge parts of the central awning sheets 112 which are to be woven next time.

When the sector S1 is woven, some (two strands) of the rear bands 110 are woven by crossly weaving the warps and the wefts with the warps {p1,p3} made of LM yarns supplied from a warp supply portion and with the wefts t11 and t12 made of ATYs supplied from rapiers of a weft supply portion.

After some of the warps and the wefts of the rear bands 110 are crossly woven, some (two strands) of the central awning sheets 112 are woven by crossly weaving the warps and the wefts with the warps {p2,p5} {p4,p7} made of LM yarns supplied from the warp supply portion and with the wefts t21 and t22 made of ATYs supplied from the rapiers of the weft supply portion.

After some of the warps and the wefts of the central awning sheets 112 are crossly woven, some (two strands) of the front bands 114 are woven by crossly weaving the warps and the wefts with the warps {p6,p8} made of LM yarns supplied from the warp supply portion and with the wefts T31 and T33 made of ATYs supplied from the rapiers of the weft supply portion.

Like shown above, as the process of weaving some of the rear bands 110, the central awning sheets 112, and the front bands 114 is repeatedly performed many times, the rear bands 110, the central awning sheets 112, and the front bands 114 of the sector S1 are completed like shown in FIG. 19, and during the weaving process, the wefts are sequentially injected in the aforementioned order and the warps are woven up and down through warp shedding movements indicated in the weaving diagram of FIG. 17.

After the rear bands 110, the central awning sheets 112, and the front bands 114 are integratedly woven in the triple type in the sector S1 like shown in FIG. 19, a warp and weft weaving process of injecting front cut yarns 140 as wefts is performed, and then, a double-weaving process is performed for the front and rear connecting portions 118 and 116 in the sector S2.

Namely, before the front connecting portions 118 are formed on lower side edges of the current central awning sheets 112 in the sector S2, the front cut yarns 140 are first injected as wefts like shown in FIG. 20. Also, before the front cut yarns 140 are injected as the wefts, the warps p2 and p4 which are the first elements of warp pairs {p2,p5} and {p4,p7} used for the warps of the central awning sheets 112 among the warps p1 to p8 are woven up on the wefts through warp shedding movements, and the rest warps p1,p3 and p5-p7 are woven down on the wefts.

Although it is desirable to locate the weft-injected position of the front cut yarns 140 to a spot made before the front connecting portions 118 are formed on the lower side edges of the current central awning sheets 112, it would be desirable if only the weft-injected position of the front cut yarns 140 is put in the vicinity of the front connecting portions 118. For instance, the position may be located within the front connecting portions 118 or on the front bands 114 near to the front connecting portions 118.

Since the warps p2 and p4 are for the central awning sheets 112 and exposed to the front side of the front cut yarns 140 or become some warps of the rear connecting portions 116 which are thermally bonded together, the central awning sheets 112 and the rear connecting portions 116 are separated from each other as the warps p2 and p4 are cut, if the front cut yarns 140 are pulled to the front and removed therefrom after the curtain is completely woven. The second elements p5 and p7 of the warp pairs {p2,p5} and {p4,p7} of the central awning sheets 112 and the warps {p6,p8} for the front bands 114 still exist in the front connecting portions 118 even though the warps p2 and p4 are cut. Consequently, the central awning sheets 112 and the front bands 114 are connected together.

After the warps and the wefts are woven with the front cut yarns 140, some (two strands) of the rear connecting portions 116 of the sector S2 for connecting new central awning sheets 112 with the previously-woven rear bands 112 are woven on upper side edges of the newly-woven central awning sheets 112.

The front connecting portions 118 and the rear connecting portions 116 for connecting the upper and lower side edges of the central awning sheets 112 are woven in the double type like shown in FIG. 20.

Referring to FIG. 20, in rear connecting portions 116 of a sector S2, first elements p2 and p4 of two pairs of warps {p2,p5} and {p4,p7} which are employed to form the previous central awning sheets 112 are used together with warps {p1,p3} which are employed to form the previously-woven rear bands 110, and wefts t31 and t32 mixed with LM yarns or LM yarns/polyester staple fiber yarns supplied through rapiers of a weft supply portion are sequentially used whereby the warps and the wefts are crossly woven, and as a result, some (two strands) of the rear connecting portions 116 are woven.

After some of the warps and the wefts of the rear connecting portions 116 are crossly woven, some (two strands) of the front connecting portions 118 are woven through a cross-weaving process for the warps and the wefts by sequentially using warps p5 and p7 and {p6,p8} that are made of LM yarns supplied from the warp supply portion and wefts t41 and t42 that are mixed with LM yarns or LM yarns/polyester staple fiber yarns supplied through the rapiers of the weft supply portion.

More specifically referring to FIG. 20, in the front connecting portions 118 of the sector S2, the second elements p5 and p7 of the two pairs of the warps {p2,p5} and {p4,p7} which are employed to form the central awning sheets 112 are used together with the warps {p6,p8} which are employed to form the previously woven front bands 114, and the wefts t41 and t42 mixed with the LM yarns or the LM yarns/polyester staple fiber yarns supplied from the rapiers of the weft supply portion are used whereby cross-weaving processes for the warps and the wefts are sequentially performed, and as a result, some (two strands) of the front connecting portions 118 are woven.

Like shown above, as the process of weaving some of the rear connecting portions 116 and the front connecting portions 118 is repeatedly performed many times, the rear connecting portions 116 and the front connecting portions 118 of the sector S2 are completely woven like shown in FIG. 20, and during the weaving process, the wefts are sequentially injected in the aforementioned order in the sector S2 shown in the weaving diagram of FIG. 17, and the warps are woven up and down through warp shedding movements indicated in the sector S2 within the weaving diagram of FIG. 17.

Right after the rear connecting portions 116 and the front connecting portions 118 are integratedly woven in the double type in the sector S2 like shown in FIG. 20, a warp and weft weaving process of injecting rear cut yarns 142 as wefts is immediately carried out.

That is to say, before the rear bands 110, the central awning sheets 112, and the front bands 114 are formed in the new sector S1 which is repeated again, the rear cut yarns 142 are first injected like shown in FIG. 20. Also, before the rear cut yarns 142 are injected as the wefts, the second elements p5 and p7 of the warp pairs {p2,p5} and {p4,p7} which are employed for the warps of the central awning sheets 112 among the warps p1-p8 are woven down on the wefts through warp shedding movements and the rest warps p1-p4, p6 and p8 are woven up on the wefts.

Although it is desirable to locate the weft-injected position of the rear cut yarns 142 to a spot made right after the rear connecting portions 116 and the front connecting portions 118 are integratedly woven in the double type, it would be desirable if only the weft-injected position of the rear cut yarns 142 is put in the vicinity of the rear connecting portions 116. For instance, the position may be located within the rear connecting portions 116 or on the rear bands 110 near to the rear connecting portions 116.

Since the warps p5 and p7 are for the central awning sheets 112 and exposed to the rear side of the rear cut yarns 142 or become some warps of the front connecting portions 118 which are thermally bonded together, the central awning sheets 112 and the front connecting portions 118 are separated from each other as the warps p5 and p7 are cut, if the rear cut yarns 142 are pulled to the back and removed therefrom after the curtain is completely woven. The first elements p2 and p4 of the warp pairs {p2,p5} and {p4,p7} of the central awning sheets 112 and the warps {p1,p3} for the rear bands 110 still exist in the rear connecting portions 116 even though the warps p5 and p7 are cut. Consequently, the central awning sheets 112 and the rear bands 110 are connected together as they are.

A woven curtain fabric like shown in FIG. 18 is obtained by collectively weaving the three-dimensional curtain sheet fabric 200 through the above weaving process of repeating the sectors S1 and S2, and then heat treatment is applied with no need to apply any chemical solution for attaching the LM yarns of the warps and the wefts.

After passing through the heat treatment, the three-dimensional curtain sheet fabric 200 shows the following advantages. For example, if the front and rear bands 110 and 114 are woven by LM yarns, the warps and the wefts are bonded together by a melting process whereby they do not slide, and the front connecting portions 118 and the rear connecting portions 116 where a plurality of LM yarns are included in the warps and the wefts can be fixed more firmly by thermally bonding the sheath parts of the warps and the wefts through the melting process.

After the above heat treatment, the wefts formed between the front bands 114 and between the rear bands 110 which are unnecessarily located on the front side of the three-dimensional curtain sheet fabric 200 are sheared, and then, if some of the warps p2, p4, p5 and p7 for the central awning sheets are respectively cut by pulling over the respective cut yarns 140 and 142 located on the front and the back, a fabric woven in the plane type like shown in FIG. 18 becomes the three-dimensional curtain sheet fabric 200 having a stereoscopic shape like shown in FIG. 14 and FIG. 15.

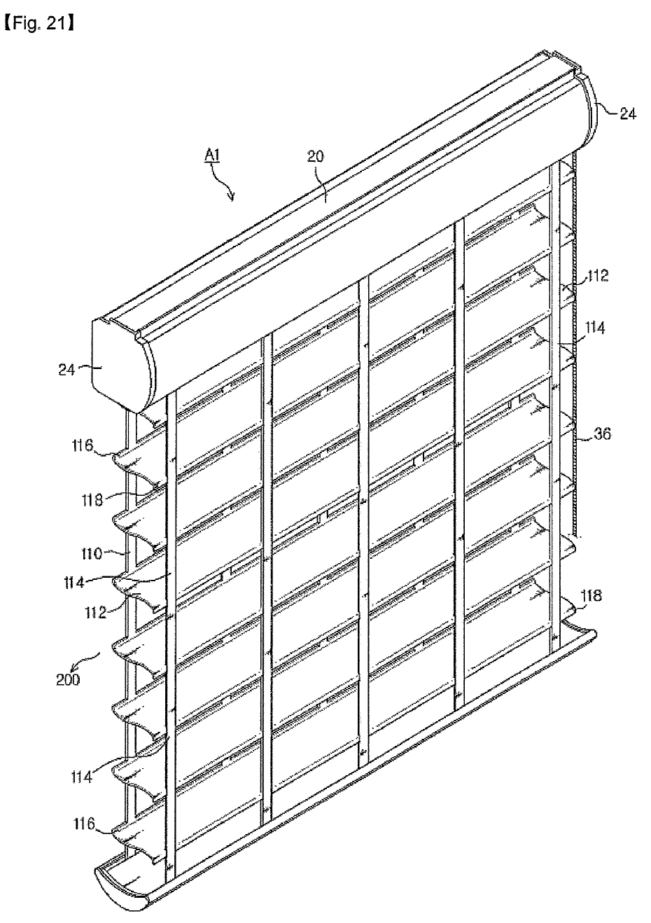

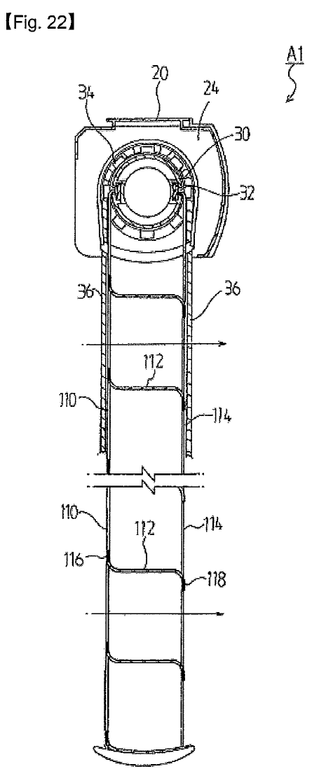

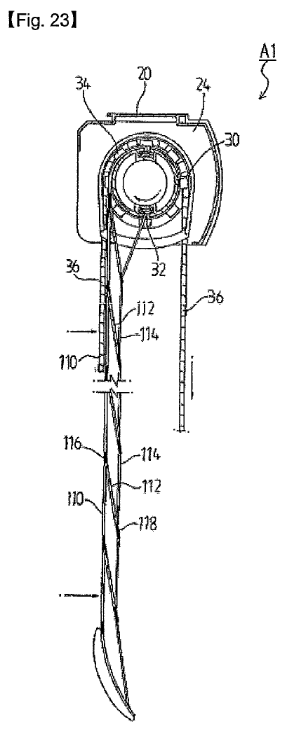

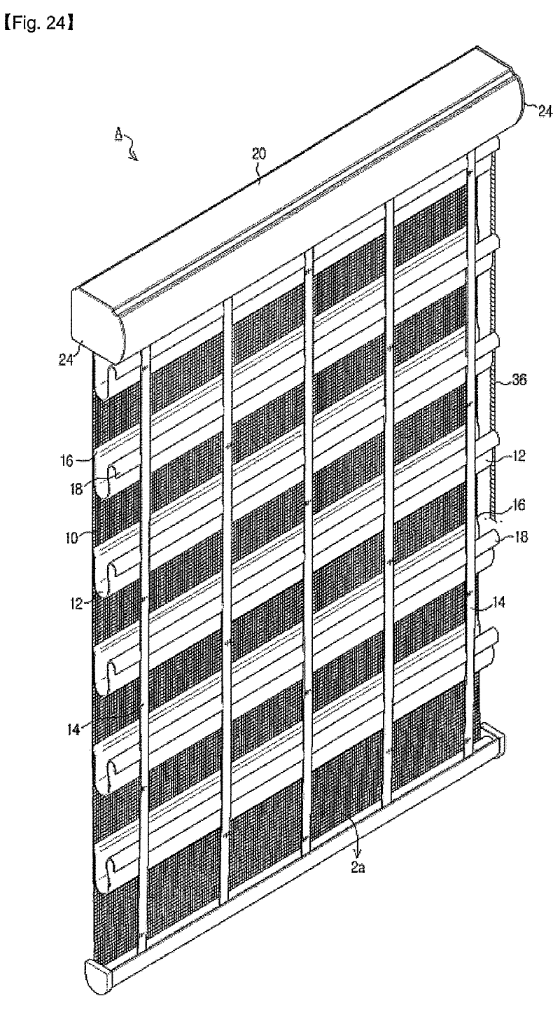

FIG. 21 is a perspective view of a window shielding apparatus for mounting a three-dimensional curtain sheet fabric 200 in accordance with another embodiment of the present invention, and FIG. 22 and FIG. 23 are side sectional views for describing an operated state of a three-dimensional curtain sheet 200.

A three-dimensional curtain sheet fabric 200 woven in the triple type according to another embodiment of the present invention is coupled and fixed to a horizontal slit coupling groove 32 of a driving axial bar 30 that is axially rotated between both brackets 24 of a frame 20 of a window shielding apparatus A like shown in FIG. 21. Rear bands 110 and central awning sheets 112 of the curtain sheet fabric 200 are inserted and fixed toward the rear side of the horizontal slit coupling groove 32, and front bands 114 are inserted and fixed toward the front side of the horizontal slit coupling groove 32 in order to be coupled and fixed thereto. Then, lift controlling strings 36 are engaged with a chain wheel 34 coupled with one side end of the driving axial bar 30 to make the curtain sheet fabric 200 rise up and down once the user pulls the lift controlling strings 36. For example, if the user pulls a rear string of the lift controlling strings 36, the three-dimensional curtain sheet fabric 200 is unfastened from the rotating driving axial bar 30 and lifted down, but if the user pulls a front string of the lift controlling strings 36, the three-dimensional curtain sheet fabric 200 is lifted up as being wound on the driving axial bar 30 which rotates reversely.

If the rear string of the lift controlling strings 36 is further pulled in a state of the three-dimensional curtain sheet fabric 200 being fully lifted down, the front bands 114 lift up the front connecting portions 118 positioned on lower side edges of all of the central awning sheets 112 as the rear bands 110 coupled with the driving axial bar 30 move to the rear side and at the same time as the front bands 114 coupled with the driving axial bar 30 move to the front side, like shown in the side sectional view of FIG. 22. Accordingly, all of the awning sheets 112 become in the horizontal state, thereby forming floodlighting portions which are opened back and forth on the three-dimensional curtain sheet fabric 200.

Further, if the front string of the lift controlling strings 36 is slightly pulled over in a state of the floodlighting portions being formed on the three-dimensional curtain sheet fabric 200, the front bands 114 release the front connecting portions 118 formed on the lower side edges of all of the central awning sheets 112 as the central awning sheets 112 and the rear bands 110 coupled with the driving axial bar 30 move to the upper side and at the same time as the front bands 114 coupled with the driving axial bar 30 move to the lower side, whereby the central awning sheets 112 are lifted down and closed, like shown in FIG. 22. Accordingly, the floodlighting portions which are opened back and forth are covered by the central awning sheets 112 and converted into awning portions.

A window shielding apparatus Al having a three-dimensional curtain sheet fabric 200 in accordance with another embodiment of the present invention have only front and rear bands 114 and 110 which are sparsely isolated from each other during the formation of floodlighting portions, showing the superior ventilation and floodlighting effects. Further, since the front and rear bands 114 and 110 firmly connect and fix the central awning sheets 112, the invention has strong durability without the transformation of a shape even though the user strongly pulls the awning sheets 112 or the front and rear bands 114 and 110.

Although preferred embodiments of the present invention have been described for illustrative purposes, those skilled in the art will appreciate that various modifications, additions and substitutions are possible, without departing from the scope and the spirit of the invention as disclosed in the accompanying claims.

### INDUSTRIAL APPLICABILITY

The present invention can be used as a three-dimensional curtain which is integratedly woven in the triple type with the easy floodlighting, ventilating and shielding effects in the strongly connected structure.

1. A curtain sheet fabric comprising a three-dimensional curtain sheet 2 in the integrated triple-woven type on which a plurality of awning cover sheets 12 are arranged up and down on bottom mesh sheets 10 and connection bands 14 isolated at certain intervals are arrayed right and left on the awning cover sheets 12, wherein upper connecting portions 16 for connecting the bottom mesh sheets 10 with the awning cover sheets 12 in the warp and weft integrated-weaving type are formed on each upper side edge of the awning cover sheets 12 while lower connecting portions 18 for connecting the awning cover sheets 12 with the connection bands 14 in the warp and weft integrated-weaving type are formed on each lower side edge of the awning cover sheets 12, and
before the lower side edges of the awning cover sheets 12 are separated and opened, cut yarns 40 for cutting warps that connect the lower side connecting portions 18 of the awning cover sheets 12 and the bottom mesh sheets 10 are formed in the vicinity between the bottom mesh sheets 10 and the rear upper connecting portions 16 and wefts which should be sheared are positioned between the adjacent connection bands 14.

2. The curtain sheet fabric having one-sided bands of claim 1, wherein the upper connecting portions 16 connect the upper side edges of the awning cover sheets 12 to the bottom mesh sheets 10 through the integrated weaving process using wefts that include LM yarns and one pair of common warps for both of the mesh sheets and the awning sheets and dedicated warps made of LM yarns for the mesh sheets only, and the lower connecting portions 18 connect the connection bands 14 to the lower side edges of the awning cover sheets 12 through the integrated weaving process using wefts that include LM yarns and the other pair of the common warps for both of the mesh sheets and the awning sheets and dedicated warps for the connection bands only.

3. The curtain sheet fabric having the one-sided bands of claim 1, wherein the warps of the bottom mesh sheets 10, the awning cover sheets 12, and the connection bands 14 are LM yarns, the wefts of the bottom mesh sheets 10 are LM yarns, the wefts of the awning cover sheets 12 and the connection bands 14 are ATYs, the wefts of the rear upper connecting portions 16 are LM yarns and ATYs, and the wefts of the front lower connecting portions 18 are LM yarns and polyester staple fiber yarns.

4. A manufacturing method of a three-dimensional curtain sheet fabric for forming a plane curtain sheet fabric in the integrated triple-woven type on which a plurality of awning cover sheets 12 that consist of warp LM yarns and awning wefts are vertically arranged on bottom mesh sheets 10 of which at least one of warps and wefts is an LM yarn, and which connection bands 14 that are made of warp LM yarns and band wefts and isolated at certain intervals are horizontally arrayed on the awning cover sheets 12, wherein cut yarns 40 for cutting warps that connect lower connecting portions 18 of the awning cover sheets 12 and the bottom mesh sheets 10 are positioned between final wefts of upper connecting portions 16 and first wefts of the bottom mesh sheets 10 after being injected in the weft type, and the upper connecting portions 16 for connecting the bottom mesh sheets 10 with the awning cover sheets 12 in the warp and weft integrated-weaving type including LM yarns as wefts are formed on each upper side edge of the awning cover sheets 12 while the lower connecting portions 18 for connecting the awning cover sheets 12 with the connection bands 14 in the warp and weft integrated-weaving type including LM yarns as wefts are formed on each lower side edge of the awning cover sheets 12 whereby the plane curtain sheet fabric may be obtained, and
after heat treatment is applied to the obtained curtain sheet fabric, the wefts existing among the connection bands 14 are sheared and turned over at the back, then the cut yarns 40 are pulled over to separate and open the lower connecting portions 18 of the awning cover sheets 12 from the bottom mesh sheets 10, thereby obtaining a final three-dimensional curtain sheet.

5. A curtain sheet fabric for forming a three-dimensional curtain sheet 2 in the integrated triple-woven type on which a plurality of awning cover sheets 12 are vertically arranged on bottom mesh sheets 10 and connection bands 14 horizontally isolated at certain intervals are arrayed on the awning cover sheets 12, wherein upper connecting portions 16 for connecting the awning cover sheets 12 with the bottom mesh sheets 10 in the warp and weft integrated-weaving type are formed on each upper side edge of the awning cover sheets 12 while lower connecting portions 18 for connecting the awning cover sheets 12 with the connection bands 14 in the warp and weft integrated-weaving type are formed on each lower side edge of the awning cover sheets 12, and the respective warps of the bottom mesh sheets 10, the awning cover sheets 12, the connection bands 14, and the upper and lower connecting portions 16 and 18 are LM yarns and the wefts of the upper connecting portions 16 and the lower connecting portions 18 are mixed with LM yarns.

6. The three-dimensional curtain sheet fabric of claim 5, wherein the wefts of the connection bands 14 are either ATYs or LM yarns.

7. A curtain sheet fabric for forming a three-dimensional curtain sheet 200 in the integrated triple-woven type on which front and rear bands 114 and 110 horizontally isolated at certain intervals are arrayed on the front and the back of a plurality of central awning sheets 112 which are arranged up and down, wherein rear connecting portions 116 for connecting the central awning sheets 112 with the rear bands 110 in the warp and weft integrated-weaving type are formed on each upper side edge of the central awning sheets 112 while front connecting portions 118 for connecting the front bands 114 with the central awning sheets 112 in the warp and weft integrated-weaving type are formed on each lower side edge of the central awning sheets 112, and
before the front and rear connecting portions 118 and 116 which are connected together after woven are separated, front cut yarns 140 for cutting awning warps that connect the front connecting portions 118 of the central awning sheets 112 and the rear bands 110 in the front direction are arranged and woven in the weft type in the vicinity of the front connecting portions 118, and rear cut yarns 142 for cutting awning warps that connect the front bands 114 and the rear connecting portions 116 of the central awning sheets 112 in the rear direction are arranged and woven in the weft type in the vicinity of the rear connecting portions 116, and respective wefts 150 and 154 which should be sheared are positioned between the adjacent front bands 114 and the adjacent rear bands 110.

8. The three-dimensional curtain sheet fabric of claim 7, wherein the rear connecting portions 116 are formed by integratedly weaving warps of two strands of two pairs of warps for the central awning sheets and one pair of the warps for the rear bands with wefts that include LM yarns, and the front connecting portions 118 are formed by integratedly weaving warps of the rest two strands of the two pairs of the warps for the awning sheets and one pair of the warps for the front bands with wefts that include LM yarns.

9. The three-dimensional curtain sheet fabric of claim 7, the warps of the central awning sheets 112 and the front and rear bands 114 and 110 are LM yarns, the wefts of the awning sheets 112 are ATYs, and the wefts of the front and rear connecting portions 118 and 116 are mixed with LM yarns.

10. The three-dimensional curtain sheet fabric of claim 9, wherein the wefts of the front and rear bands 114 and 110 are either ATYs and LM yarns.

11. A manufacturing method of a three-dimensional curtain sheet fabric for forming a plane curtain sheet in the integrated triple-woven type on which front and rear bands 114 and 110 horizontally isolated at certain intervals are arrayed on the front and the back of a plurality of awning sheets 112 which are arranged up and down, wherein rear connecting portions 116 for connecting the central awning sheets 112 with the rear bands 110 in the warp and weft integrated-weaving type are formed on each upper side edge of the central awning sheets 112 while front connecting portions 118 for connecting the front bands 114 with the central awning sheets 112 in the warp and weft integrated-weaving type are formed on each lower side edge of the central awning sheets 112, and front cut yarns 140 for cutting awning warps that connect the front connecting portions 118 of the central awning sheets 112 and the rear bands 110 in the front direction are arranged and woven in the weft type in the vicinity of the front connecting portions 118, and rear cut yarns 142 for cutting awning warps that connect the front bands 114 and the rear connecting portions 116 of the central awning sheets 112 in the rear direction are arranged and woven in the weft type in the vicinity of the rear connecting portions 116 whereby the plane curtain sheet fabric may be obtained, and after heat treatment is applied to the obtained curtain sheet fabric, wefts 150 and 154, existing among the front and rear bands 114 and 110 are sheared, and the front and rear cut yarns 140 and 142-are pulled over to cut some warps of the awning sheets, thereby finally forming a three-dimensional curtain sheet fabric 200.

12. A curtain sheet fabric for forming a three-dimensional curtain sheet 200 in the integrated triple-woven type on which front and rear bands 114 and 110 horizontally isolated at certain intervals are arrayed on the front and the back of a plurality of awning sheets 112 which are arranged up and down, wherein rear connecting portions 116 for connecting the central awning sheets 112 with the rear bands 110 in the warp and weft integrated-weaving type are formed on each upper side edge of the central awning sheets 112 while front connecting portions 118 for connecting the front bands 114 with the central awning sheets 112 in the warp and weft integrated-weaving type are formed on each lower side edge of the central awning sheets 112, and the warps of the central awning sheets 112, the front and rear bands 114 and 110, and the front and rear connecting portions 118 and 116 are LM yarns, and the wefts of the front and rear connecting portions 118 and 116 are either LM yarns or mixed yarns including the LM yarns.

13. The curtain sheet fabric having the one-sided bands of claim 2, wherein the warps of the bottom mesh sheets 10, the awning cover sheets 12, and the connection bands 14 are LM yarns, the wefts of the bottom mesh sheets 10 are LM yarns, the wefts of the awning cover sheets 12 and the connection bands 14 are ATYs, the wefts of the rear upper connecting portions 16 are LM yarns and ATYs, and the wefts of the front lower connecting portions 18 are LM yarns and polyester staple fiber yarns.

14. The three-dimensional curtain sheet fabric of claim 8, the warps of the central awning sheets 112 and the front and rear bands 114 and 110 are LM yarns, the wefts of the awning sheets 112 are ATYs, and the wefts of the front and rear connecting portions 118 and 116 are mixed with LM yarns.

15. The three-dimensional curtain sheet fabric of claim 14, wherein the wefts of the front and rear bands 114 and 110 are either ATYs and LM yarns.
